(19) United States
(12) Patent Application Publication
(10) Pub. No.: US 2017/0070971 A1
(43) Pub. Date: Mar. 9, 2017

(54) METHODS AND SYSTEMS FOR COLLABORATIVE GLOBAL NAVIGATION SATELLITE SYSTEM (GNSS) DIAGNOSTICS

(71) Applicant: QUALCOMM Incorporated, San Diego, CA (US)

(72) Inventors: Richard Wietfeldt, San Diego, CA (US); Stephen William Edge, Escondido, CA (US)

(21) Appl. No.: 14/845,936

(22) Filed: Sep. 4, 2015

(51) Int. Cl. H04W 64/00; G01S 19/07; H04W 24/10

(52) U.S. Cl. CPC H04W 64/00; H04W 24/10; G01S 19/07

(57) ABSTRACT

Disclosed are systems, methods and techniques for determining or inferring a status or fault for a portion or aspect of a global navigation satellite system (GNSS). For example, fault messages may be received from multiple mobile devices where fault messages provide indicators indicative of events or conditions. Fault indicators in received fault messages obtained from messages received from two or more of the mobile devices may be combined to infer a status or fault of at least a portion of a GNSS. Augmentation parameters conveying information related to an inferred fault may be transferred to a mobile device to improve GNSS location of the mobile device.

### BACKGROUND

Field

Aspects of the present disclosure relate generally to Global Navigation Satellite Systems (GNSS) and methods to improve their reliability by collaborative techniques among GNSS operators, reference augmentation networks, and receiver elements including consumer smartphones and other handheld devices.

Information

Global Navigation Satellite Systems (GNSS) are widely deployed to provide the ability for ground or air-based GNSS receivers to derive their positions, velocities, and timing, often referred to as “PVT.” This is also often referred to as position, navigation, and timing, or PNT. Examples of GNSS systems or constellations include U.S. GPS (Global Positioning System), Russian GLONASS (Global Orbiting Navigation Satellite System), European Galileo, Chinese Compass/BeiDou (BDS or BeiDou Navigation Satellite System), Indian IRNSS (Indian Regional Navigational Satellite System), Japanese QZSS (Quazi Zenith Satellite System), etc. Currently, each GNSS constellation is generally operated independently of each other, but with increasing formal communication amongst satellite operator nations, and with more coordination expected in the future to gain the benefits of these valuable positioning resources, including relating to potential fault identification messages as discussed herein.

Generally, a GNSS receiver supports processing of signals from one GNSS constellation at a time, but advances in microelectronics now permit receivers at a mobile device to support multiple and concurrent reception and processing of two or more GNSS constellations. By virtue of this concurrent operation, it is possible for a single GNSS receiver to derive its PVT from one or more specific GNSS constellations.

A GNSS receiver may be included in many products and civil and defense infrastructure elements in different forms. It may be included in a user equipment device (UE) comprising mobile devices ranging from handheld receivers used by hikers or drivers, to smartphones, and to more sophisticated, specialized receivers used for high-end survey and mapping applications where higher positioning accuracy is desired or required. It may also be included in future products for the purpose of implemented aspects described herein. While specific examples provided herein refer to a user equipment (UE), specific implementations or embodiments may be directed to any handheld or non-handheld entity comprising one or more GNSS receivers included. A UE may also comprise more than one GNSS receiver. Such a multi-GNSS receiver may enable improvements in a time to first fix (TTFF), for diversity operation if, for example, one antenna and/or receiver is experiencing a higher signal-to-noise ratio (SNR) than another receiver, and for other functions.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device in accordance with an implementation.

FIG. 2 is a schematic diagram of a system to perform diagnostics on at least one aspect of a global navigation satellite system (GNSS) in accordance with an implementation.

FIG. 3 is a schematic diagram illustrating messaging between a multi-GNSS location server and one or more mobile devices according to an embodiment.

FIG. 4 is a flow diagram of a process for inferring a status of an aspect of a GNSS based on fault messages received from mobile devices according to an embodiment.

FIG. 5 is a flow diagram of a process at a mobile device for providing fault messages and receiving positioning assistance messages according to an embodiment.

FIG. 6 is a schematic block diagram illustrating an exemplary device, in accordance with an implementation.

FIG. 7 is a schematic block diagram of an example computing system in accordance with an implementation.

### SUMMARY

Briefly, particular implementations are directed to a method at a location server comprising: receiving reporting messages from a plurality of reporting mobile devices, the reporting messages comprising indications of locations of at least one of the plurality of reporting mobile devices and one or more status indicators related to satellite positioning system (SPS) signals transmitted from one or more global navigation satellite system (GNSS) transmitters; correlating the status indicators received from different ones of the plurality of reporting mobile devices based, at least in part, on a fault indicator type, condition or event type, the indications of locations, device type, device brand, device model, GNSS, space vehicle (SV) identifier or SV signal, or any combination thereof, to determine a status message, the status message comprising an indication of availability of service from at least one of the one or more GNSS transmitters; and transmitting the status message to one or more target devices.

Another particular implementation is directed to a location server comprising: a communication interface to transmit messages to and receive messages from a communication network; and one or more processors configured to: obtain reporting messages received at the communication interface from a plurality of reporting mobile devices, the reporting messages comprising indications of locations of at least one of the plurality of reporting mobile devices and one or more status indicators related to satellite positioning system (SPS) signals transmitted from one or more global navigation satellite system (GNSS) transmitters; correlate the status indicators received from different ones of the plurality of reporting mobile devices based, at least in part, on a fault indicator type, condition or event type, the indications of locations, device type, device brand, device model, GNSS, space vehicle (SV) identifier or SV signal, or any combination thereof, to determine a status message, the status message comprising an indication of availability of service from at least one of the one or more GNSS transmitters; and initiate transmission of the status message through the communication interface to one or more target client devices.

Another particular implementation is directed to a method at a mobile device comprising: obtaining an indication of a current location of the mobile device; obtaining one or more observations of satellite positioning system (SPS) signals received from one or more global navigation satellite systems (GNSS); inferring a condition or event based, at least in part, on the obtained one or more observations; and transmitting one or more messages to a server comprising the indication of the current location of the mobile device and an indication of the inferred condition or event.

Another particular implementation is directed to a mobile device comprising: a wireless transceiver to transmit messages to and receive messages from a communication network; a satellite positioning system (SPS) receiver; and one or more processors configured to: obtain an indication of a current location of the mobile device; obtain one or more observations of SPS signals received at the SPS receiver from one or more global navigation satellite systems (GNSS); infer a condition or event based, at least in part, on the obtained one or more observations; and initiate transmission of one or more messages through the wireless transceiver to a server comprising the indication of the current location of the mobile device and an indication of the inferred condition or event.

It should be understood that the aforementioned implementations are merely example implementations, and that claimed subject matter is not necessarily limited to any particular aspect of these example implementations

### DETAILED DESCRIPTION

In normal Global Navigation Satellite System (GNSS) operation, a GNSS operator may ensure the integrity or reliability of its system, and the position, velocity, or time as determined by a user equipment device (UE) from a given GNSS is assumed reliable. However, history of constellation and/or space vehicle (SV) faults indicates that the absolute reliability of a GNSS may not be necessarily assumed, and one or more “checks” outside of the GNSS's own Control Segment may be beneficial. Furthermore, even if an operator of a particular GNSS is aware of certain faults in one or more SVs and may be providing broadcast data to indicate this to certain users, other users of the GNSS (e.g. a location server for another service provider) may be temporarily unaware of the faults arising, at least in part, from delays or lack of connectivity from reference sources such as a Wide Area Reference Network (WARN).

Operation of a GNSS system by a GNSS operator may be assumed to transmit satellite positioning system (SPS) signals to remote GNSS receivers, and transmit error-free uplink command signals from a Control Segment. However, there may be errors in this process that give rise to constellation outages or errors associated with a given SV within a GNSS constellation. These errors may be generally classified as unintentional. Unfortunately, there are no explicit authentication mechanisms contained within currently operational civil GNSS signal structures and in many cases a civil community is left to rely on various consistency checks including augmentation networks.

GNSS faults such as constellation or ground error may be global and detectable in a constellation's world-wide monitoring network. However, constellation monitoring may be independent and diverse across constellations and operators, and may not be uniform among all GNSS constellations. In other words, monitoring of coverage may be high quality in some GNSS constellations, but may not be universally guaranteed for all GNSS constellations. In addition, many GNSS systems have a prioritized area of coverage—e.g. the Asia-Pacific region in the case of Beidou or the European region in the case of Galileo. This may be accompanied by unequal world-wide monitoring where faults in SVs currently visible in non-prioritized areas but not in prioritized areas may be detected more slowly or not at all compared to faults in SVs visible in a prioritized area. This may lead to a greater incidence of faults for non-prioritized areas that are not quickly detected by a GNSS operator.

A multi-GNSS receiver, appropriately configured, may be able to detect conditions suggestive of a fault but not necessarily unambiguously detect constellation/system errors. The multi-GNSS receiver may report potential error sources in the form of “fault messages” to a central server comprising indicators or descriptors of one or more conditions or events suggestive of a fault. Final determination of an erroneous condition may be made by the central server examining fault messages from multiple, geographically dispersed, GNSS receivers in a region or around the globe.

It is to be understood that in any particular scenario there may be a plethora of disparate entities with a mission to detect and localize sources of GNSS interference in real time and in a given geographical area. In one example, the Australian initiative GNSS Environmental Monitoring System (GEMS) endeavors to detect and localize interferers in real time in a given area. GEMS consists of a number of spatially distributed sensor nodes incorporating antenna arrays connected to a central processing unit. An interference source may be localized using hybrid Angle-of-Arrival (AOA) and Time-Difference-of-Arrival (TDOA) techniques. Many other monitor networks, both civil and military oriented are deployed. As described herein, UEs based on smartphone technology and a central element (e.g., server) may assist or augment monitoring systems in monitoring GNSS performance for vast geographies.

In another aspect, deliberate interference sources may bring about intentional errors that may bring about GNSS receiver errors. Potential mechanisms providing deliberate interference sources may include: (a) Jamming GNSS signals with interference in or near the receive frequency band of the receiver, or by other means; (b) Rebroadcasting or “meaconing” GNSS signals maliciously, accidentally or on purpose to improve reception but causing misreporting of a position; (c) Spoofing GNSS signals to create a controllable misreporting of position, for example to deceive tracking devices, just to provide a few examples. Such effects may be generally localized in nature and may this pass unnoticed by the operator of an affected GNSS system. A system to detect such local disruption errors is desirable.

Jamming and spoofing may be localized phenomena, where aggressors disrupt one or more GNSS receivers in a specific geographic area. In some cases, the jamming or spoofing may be intended to be extremely local (e.g. disruption of PVT determination for speed controlled trucks, taxis or delivery vehicles) but may have unintended wider effects. In other cases, the wider effects may be deliberate and intended (e.g. to create small timing errors for a stock market trading center or delayed air traffic at an airport). A multi-GNSS receiver in the affected area may be able to identify which GNSS constellations provide a valid or reliable PVT solution and those GNSS constellations which do not, implying an ability to identify the presence of an aggressor in the specific geographic area. GNSS receiver generated fault messages may be transmitted to a central server for analysis and a final determination of a GNSS fault condition may be made by analyzing fault messages from multiple GNSS receivers in the specific geographic area. Further analysis by the server of these reports may identify a finer granularity of the jamming area (e.g. the location of the jammer) and potentially the characteristics of the jamming source such as wideband in-band and wideband out-of-band. While individual UE measurements may vary among different particular UEs and individually may have limited ability to identify a fault or interference level, fault messages from multiple UEs may enable characterization of an impact and estimation of an impact location.

A loss of GNSS signal integrity might be considered purely an inconvenience. However, where systems are used in safety of life critical applications (e.g. at airports or by public safety responders), the consequences can be more severe. In some situations, even if GNSS operators are familiar with their internal procedures for a loss of GNSS signals, they may not understand the implications for the large number of interlinked systems that depend on GNSS reliability. The ability to safeguard against both GNSS errors and local disruption effects is desirable.

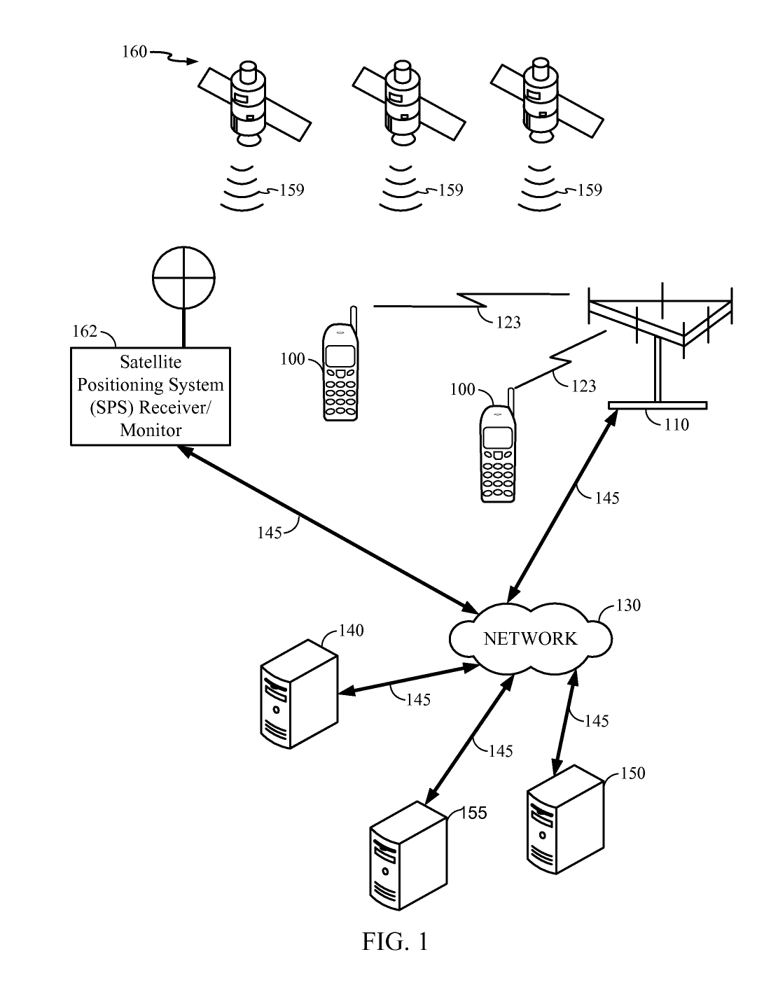

In certain implementations, as shown in FIG. 1, mobile devices 100 and satellite positioning system (SPS) receiver/monitor 162 may receive or acquire SPS signals 159 from SPS SVs 160. In some embodiments, SVs 160 may be from one global navigation satellite system (GNSS), such as the GPS or Galileo satellite systems. In other embodiments, the SPS Satellites may be from multiple, different GNSS such as, but not limited to, GPS, Galileo, Glonass, or Beidou (Compass) satellite systems. In other embodiments, SPS satellites may be from any one several regional navigation satellite systems (RNSS′) such as, for example, Wide Area Augmentation System (WAAS), European Geostationary Navigation Overlay Service (EGNOS), Quasi-Zenith Satellite System (QZSS), just to name a few examples.

In addition, mobile devices 100 may transmit radio signals to, and receive radio signals from, a wireless communication network. In one example, a mobile device 100 may communicate with a cellular communication network by transmitting wireless signals to, or receiving wireless signals from, base station transceiver 110 over wireless communication link 123. For simplicity, FIG. 1 shows mobile devices 100 as being in communication with network 130 through the same base station transceiver 110. In other implementations, mobile devices 100 may communicate with network 130 through different base station transceiver devices. Also, many more additional, geographically dispersed mobile devices (not shown) may acquire SPS signals 159 transmitted by SVs 160, and wirelessly communicate with other devices through network 130. A mobile device 100 may be referred to as a user equipment (UE), mobile station, mobile terminal, wireless device, wireless terminal, device, access terminal, station or by some other name. A mobile device may be a cellular phone, smartphone, tablet, laptop, PDA, smartwatch or any other portable device with wireless communication capability.

In a particular implementation, base station transceiver 110 may communicate with servers 140, 150 and/or 155 over a network 130 through links 145. Here, network 130 may comprise any combination of wired or wireless links. In a particular implementation, network 130 may comprise Internet Protocol (IP) infrastructure capable of facilitating communication between mobile device 100 and servers 140, 150 or 155 through local transceiver 115 or base station transceiver 110. In another implementation, network 130 may comprise cellular communication network infrastructure such as, for example, a base station controller or mobile switching center (not shown) to facilitate mobile cellular communication with mobile device 100.

In particular implementations, mobile devices 100 may receive augmentation parameters (e.g., positioning assistance or correction parameters) in messages from servers 140, 150 or 155 for use in acquisition of SPS signals 159 and/or in determining PVT results from acquired SPS signals 159. Such positioning assistance parameters may include, for example, the UE's approximate location, GNSS almanac, expected Doppler and code phase shifts for visible SVs, and GNSS approximate or real-time determined accurate SV position, orbital data and clock, just to provide a few examples. In this context, one or more of servers 140, 150 or 155 may comprise a “location server” such as a Secure User Plane Location (SUPL) Location Platform (SLP) as defined by the Open Mobile Alliance (OMA) or an Enhanced Serving Mobile Location Center (E-SMLC) as defined by the 3^{rd} Generation Partnership Project (3GPP). Correction parameters may include, for example, orbit (ephemeris or SV position data) and time/clock corrections, and differential corrections including pseudorange and/or carrier phase Real Time Kinematic (RTK) data, just to provide a few examples.

In a particular implementation, SPS receiver/monitor 162 may monitor the behavior of SVs 160 based on acquired SPS signals 159 to, for example, detect conditions that may be indicative of faults or erroneous operation. These faults or erroneous conditions may arise from any one of several aspects of SPS signals 159 as discussed below. These faults or erroneous conditions may be reported by SPS receiver/monitor 162 in messages transmitted to one or more of servers 140, 150 or 155 through network 130. Based, at least in part, on these faults or erroneous conditions, one or more of servers 140, 150 or 155 may modify or alter augmentation parameters to be furnished to mobile devices 100. As discussed below, in particular implementations servers 140, 150 or 155 may combine fault messages received from multiple mobile devices to modify or alter augmentation parameters.

According to an embodiment, mobile devices 100 may detect conditions that may be indicative of a fault or erroneous operation of one or more GNSSs based, at least in part, on acquisition of SPS signals 159. Mobile devices 100 may transmit fault messages indicting the detected conditions to one or more of servers 140, 150 or 155 through network 130. One or more of servers 140, 150 or 155 may then characterize or infer faults occurring for a specific GNSS based on faults or erroneous conditions reported by SPS receiver/monitor 162 and fault messages received from mobile devices 100. The fault or faults inferred for a specific GNSS may be caused by one or more faults in an SV or SVs for the specific GNSS (e.g. a timing error or signal error) or may be caused by outside sources (e.g. intentional or unintentional jamming). The inference of the fault may then determine the consequences to GNSS receivers and may, in some cases, also determine the likely cause and area of impact.

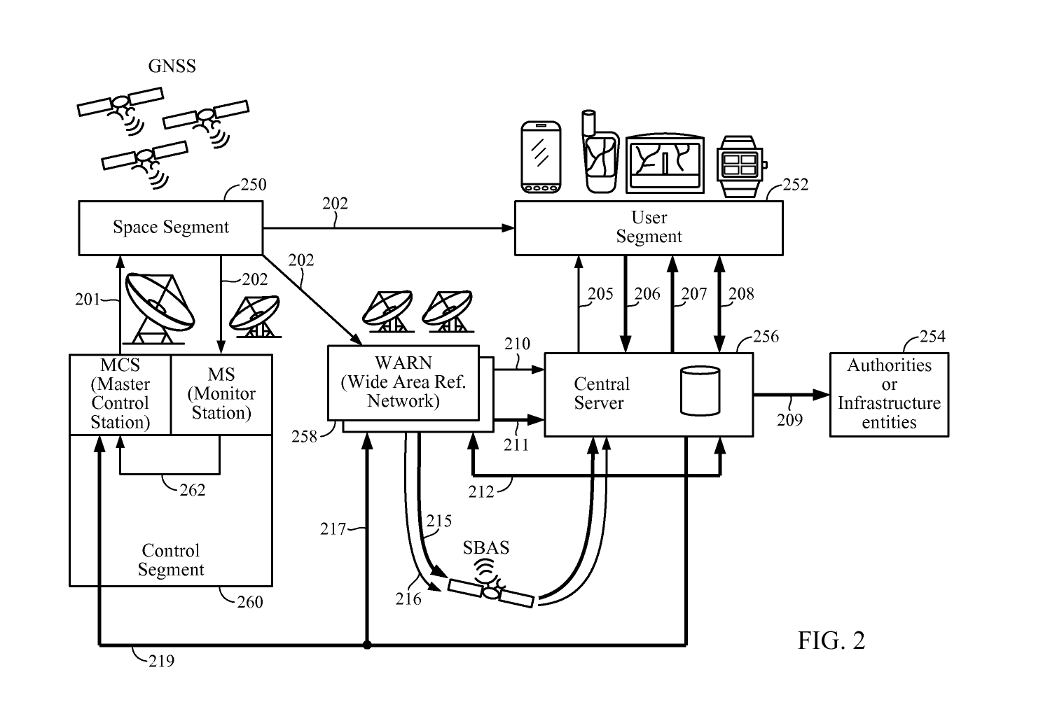

FIG. 2 is a schematic diagram of a system to perform diagnostics on at least one aspect of a global navigation satellite system (GNSS) comprising a Space Segment 250 (e.g., including SVs 160), a Central Server 256 (e.g., including one or more of servers 140, 150 or 155), a WARN 258 (e.g., including an SPS receiver/monitor 162), a Control Segment 260 (e.g., including an SPS receiver/monitor 162 and/or one or more of servers 140, 150 and 155) and a User Segment 252 (e.g., including mobile devices 100). Space Segment 250 may comprise SVs for multiple, different GNSS systems or constellations currently in place or in planning and/or development phases, such as the U.S. GPS (Global Positioning System), Russian GLONASS (Global Orbiting Navigation Satellite System), European Galileo, Chinese BeiDou/Compass (BDS or BeiDou Navigation Satellite System), Indian IRNSS (Indian Regional Navigational Satellite System), and Japanese QZSS (Quazi Zenith Satellite System), just to provide a few examples. Furthermore, some of these constellations may serve dual functions of GNSS navigation beacons and augmentation systems including Space Based Augmentation Systems (SBAS) often in different orbits such as geostationary orbits than their GNSS beacon counterparts.

In FIG. 2, WARN message 215 (216) may be functionally similar to WARN message 211 (210), except that 215 (216) may be sent through the SBAS to Central Server 256 whereas 211 (210) may be sent directly. Messages 206 (from User Segment 252) and 211 (from WARN 258) may be functionally similar fault indicator messages to Central Server 256. Central Server 256 messages 207 (to User Segment 252) and 217 (to WARN 258) may be functionally similar configuration and/or augmentation messages. Central Server 256 messages 209 (to Authorities 254), 217 (to WARN 258), and 219 (to Control Segment 260) may be functionally similar fault indicator messages.

In an embodiment, Central Server 256 may comprise (i) an Enhanced Serving Mobile Location Center (E-SMLC) as described in 3GPP Technical Specifications (TSs) 23.271 and 36.305; (ii) a Secure User Plane Location (SUPL) Location Platform (SLP) as defined by the Open Mobile Alliance (OMA) for the SUPL location solution; or (iii) a Home SLP (H-SLP), Discovered SLP (D-SLP) or Emergency SLP (E-SLP) as further defined by OMA, or any combination thereof. In an embodiment, any of messages 205, 206, 207 and/or 208 shown in FIG. 2 and referred to elsewhere herein, may comprise messages transmitted according to the LTE Positioning Protocol (LPP) defined in 3GPP TS 36.355, messages transmitted according to the LPP Extensions Protocol (LPPe) defined by OMA or messages transmitted according to the SUPL User plane Location Protocol (ULP) defined by OMA. In an embodiment, any of messages 205, 206, 207 and/or 208 shown in FIG. 2 may comprise (i) a ULP message in which one or more LPP messages are embedded; (ii) a ULP message in which one or more LPP messages are embedded, wherein one or more of the embedded LPP messages each contain an embedded LPPe message; or (iii) an LPP message in which one LPPe message is embedded.

For simplicity, FIG. 2 illustrates aspects of a single GNSS system/constellation. In particular embodiments, however, FIG. 2 illustrates aspects of a GNSS that may be replicated for an operating environment comprising multiple GNSSs, and multiple instantiations of the features of FIG. 2 may be considered to be in place to represent the multiple GNSS constellations. In the context here, a particular case is described of at least one Central Server 256 being in communication with one or more GNSS constellations in Space Segment 250, with one or more Wide Area Reference Networks (WARNs) 258 serving a particular GNSS constellation, and multiple UE's in User Segment 252 having single-GNSS or multi-GNSS receive capability, for example. One or more GNSSs or constellations may enable GNSS receivers on the ground (e.g., in User Segment 252) to determine their position, velocity, and/or precise time.

According to an embodiment, Space Segment 250 may comprise SVs in GNSS constellations. Such SVs may be in earth orbit and, collectively for any GNSS constellation, may be designed to provide high percentage coverage to any given position on Earth. An SV may broadcast radio signals from space referred to here as an SPS signal. An SPS signal may carry downlink data including SV-specific coded ranging signals, orbital parameters, timing/clock parameters and atmospheric data, just to provide a few examples. SPS signals 202 may be acquired by elements on the ground (e.g., a monitor station of Control Segment 260 or a UE of User Segment 252). In particular scenarios, SV motion around the Earth and local blocking conditions on the ground may degrade or completely obscure reception of SPS signals at ground elements. GNSS failures of varying types may occur in SV's of Space Segment 250, Control Segment 260 or in messages supplied to the Control Segment 260 by an external source, for example. Exemplary failure modes and methods for addressing such failure modes are described herein.

According to an embodiment, Control Segment 260 may be dedicated to one particular GNSS constellation and may comprise a ground-based network of master control stations (MCS), data uplink stations, and monitor stations (MS) whose role may be to monitor, control and determine the current status of the associated GNSS constellation. For a particular GNSS, there may be a single control segment 260 comprising one or more MCSs (for example, one primary and other backups), one or more data uploading stations and multiple Monitor Stations located throughout the world. Signals and/or messages may be exchanged between elements of the Control Segment 260 to enable proper operation of its GNSS SVs. Control Segment 260 may track GNSS SVs, monitor their transmissions, perform analyses, send commands and data to their constellation, just to provide a few examples.

In a particular GNSS system, a Master Control Station (MCS) may send messages 201 to adjust the SVs' orbit parameters (e.g. parameters that SVs broadcast to the user segment 252) and onboard high-precision clocks to maintain accuracy. A GNSS may operate Monitor Stations (MS) for integrity reasons. MSs may be installed over a broad geographic area to provide suitable coverage. An MS for a particular GNSS may monitor SVs' signals and status in order to identify outlier integrity data, and may relay integrity data to an associated MCS in messages 262. For example, a GPS MS may monitor a Precise Positioning Service (PPS) SPS signal in such a fashion. According to an embodiment, an MCS may analyze messages 262 from one or more MSs and transmit uplink messages to one or more SVs in messages 201. Uplink messages transmitted in messages 201 may comprise correction parameters for particular SVs in a constellation such as, for example, orbit (ephemeris or SV position data) and time/clock corrections to the SV's through data uplink stations. Uplink messages may also include atmospheric and almanac data.

User Segment 252 may comprise UEs capable of processing received SPS signals 202 transmitted from SVs in a GNSS to derive PVT, for example. UEs in User Segment 252 may range from handheld receivers used by hikers or drivers, to smartphones, to more sophisticated, specialized receivers used for high-end survey and mapping applications where higher positioning accuracy is desired, for example. A UE may determine its PVT from one GNSS constellation. In other implementations, a UE may simultaneously process SPS signals from multiple different GNSS constellations to determine its PVT. In some implementations, some or all UEs in user segment 252 may both measure SPS signals 202 and determine PVT (or just one component of PVT such as position) using navigation parameter(s) received in SPS signals 202 or received from a separate server such as Central Server 256 or one of servers 140, 150 or 155. In some other implementations, some or all UEs in user segment 252 may measure SPS signals 202 and send the measurements to a separate server such as Central Server 256 or one of servers 140, 150 or 155, with the server then determining PVT (or just one component of PVT such as position) for the UE using navigation data received directly from SVs or from another source such as a WARN (e.g. WARN 258). Additionally, UEs in User Segment 252 may be geographically dispersed over the Earth.

According to an embodiment, a GNSS may enable at least two types of measurements in a particular GNSS receiver that may ultimately be used to measure a range from an SV to the GNSS receiver: pseudorange (also known as code phase) and carrier phase. A precision of around ten meters down to around one meter may be achieved for location estimates derived from pseudorange measurements based on acquired SPS signals. On the other hand, centimeter or even millimeter level precision may be achieved with the carrier phase observation if an ambiguity can be determined reliably. Lower values of precision may be obtained with augmentation methods to be described herein, including differential pseudorange corrections and differential carrier phase corrections, known as differential GNSS (DGNSS).

According to particular embodiments, a UE may determine pseudorange measurements (from acquisition of SPS signals) to estimate its position, and/or its position, velocity and clock. Pseudorange measurements may vary from true values by virtue of imprecise knowledge of SV position, timing and other factors such as atmospheric variations. Corrections to pseudorange measurements may improve the accuracy of a UE derived location estimate or enable determination of higher precision UE derived location estimate. Pseudorange corrections may be received from one or more DGNSS reference station receivers and/or servers via augmentation or assist messages to be discussed herein.

A UE may also employ carrier phase measurements to determine its position, and using the radio frequency carrier signal itself in a RTK mode of operation. RTK may offer high accuracy by virtue of processing measured phases of a high frequency carrier signal. For example, the GPS L1 signal has a wavelength of about 19 cm so that achieving a measurement accuracy of a small fraction of the wavelength may result in cm to mm accuracies. Here, a number of carrier cycles transmitted from the SV to the receiver may be counted for measuring a pseudorange from the SV to a UE. However, a UE carrier phase measurement may result in some integer number of carrier cycles being measured plus a phase value in the range of 0 to 360 degrees. A pseudorange measurement may be “ambiguous” if a UE cannot discriminate the time-of-transmission of one (e.g., L1) wavelength from another. Hence the total number of carrier cycles from an SV to a UE may not be initially accurately determined. However, subsequent RTK processing may mitigate distant-dependent variables such as the ionosphere, troposphere and orbit errors to resolve ambiguities and determine an accurate SV to UE range.

In particular implementations, GNSS via multi-frequency operation involving particular signal structures at different frequencies may enable improved accuracy in pseudorange and carrier phase measurements. One error source, particularly in consumer-grade GNSS receivers may arise from single frequency operation prohibiting an ability to remove or correctly adjust for a frequency-dependent propagation delay component of the ionosphere. Here, dual frequency operation may greatly reduce ionospheric errors and therefore improve accuracy of range measurements. SVs in GNSS constellations may broadcast signals in two or more frequency bands such as L1/E1 and L5/E5 in GPS, Galileo and BeiDou/Compass, and may be available for civil aviation, allowing reduction of pseudorange and carrier phase errors arising from variations in ionospheric delay. As pertaining to discussions herein, additional messaging between GNSS System entities may assist in coordinating operational aspects related to single and/or dual frequency capabilities in constellations, SV's, and receivers.

Safety of life applications such as aviation may be subject to high reliability requirements. Here, performance of a GNSS constellation may be maintained autonomously without external assistance or reliance on external communications beyond the GNSS constellation itself. One high-reliability technique originally developed for GPS is known as Receiver Autonomous Integrity Monitor (RAIM). In a particular implementation, an aircraft may be outfitted with RAIM-enabled receivers to autonomously detect GNSS faults, in methods to be described herein. Advances to RAIM have been in place since its introduction, including more recent investigations towards multi-GNSS RAIM. In particular implementations, a RAIM technique may indeed provide reliability messages. For example, a RAIM technique may detect “faults” based on observations obtained from aircrafts that are maintained and reported among the aircrafts but not reported externally (e.g., to a central server). In other implementations, however, such observations obtained at an aircraft may be forwarded to another entity to be combined with observations from other devices. For example, observations obtained from aircrafts may be forwarded to Central Server 256 to be combined with observations obtained from User Segment 252, WARN 258 or Space Segment 250, for example.

According to an embodiment WARN 258 may comprise a set of geographically separated reference stations that receive and process SPS signals transmitted by SVs in a GNSS (e.g., in Space Segment 250). According to an embodiment, WARN 258 may be operated by a GNSS operator as part of its nominal integrity functions, or may be operated by other parties such as civil, consumer, or other entities. Within WARN 258, a reference station may be outfitted with a highly accurate clock, much more precise than those maintained in consumer UE's, and surveyed to provide a highly accurate position for the reference station. GNSS-based measurements (e.g., PVT) obtained at a reference station may be significantly more accurate than GNSS-based measurements obtained at GNSS receivers in lower cost devices such as consumer UE's (e.g. smartphones, tablets, cellphones). One or more of the WARN reference stations may communicate with a UE directly or through one or more server entities.

According to an embodiment, WARN 258 may provide services directed to enhancing augmentation and service reliability/integrity. Augmentation may enable improvement in performance or PVT accuracy of the GNSS via the generation of “correction parameters” to be applied to measurements made by GNSS receivers and/or “assistance parameters” to assist GNSS receivers in acquisition of SPS signals. Service reliability/integrity enhancements may enable derivation of accurate positions, including via the generation of “integrity” or “fault” messages to GNSS receivers that may benefit from knowledge of “erroneous” or “faulty” conditions limited to individual SV's or applicable to entire GNSS constellations.

One particular objective of WARN 258 may be to improve UE performance of UE position (PVT) determination. In an example embodiment, WARN 258 may enable or support an augmentation system in providing “differential corrections” of pseudorange and/or carrier phase to UE's to improve the position accuracy of measurements obtained by the UE's. In a different mode, WARN 258 may enable providing “absolute corrections” such as real-time derived SV and reference station positions.

WARN 258 may transmit augmentation messages to a UE, carrying assistance data to correct SPS measurements and/or assist acquisition of SV signals, in a variety of fashions involving terrestrial and/or satellite based communications. In a terrestrial mode of operation, one mode of operation may involve a local area augmentation system (LAAS), in some cases also described as a regional area augmentation system (RBAS), and another mode of operation may involve a wide area augmentation system (WAAS).

In another mode of operation WARN 258 may use one or more uplinks to one or more geostationary satellites whereby the satellite forwards signals to the UE's in a mode known as Space Based Augmentation System (SBAS). Here, messaging with WARN 258 may be facilitated at messages 215 and 216. In another mode of operation, the LBAS, RBAS, and WAAS may include the SBAS satellite. In yet another mode of operation, an individual WARN reference station may communicate messages via an SBAS satellite.

With regard to differential corrections provided by WARN 258, a deviation of the measured position to the actual position at a WARN reference station may be calculated if reference station positions are accurately known (in addition to knowing its use of an accurate clock). The deviations may be used to infer corrections to measured pseudoranges to individual SVs that may enable calculation of the correct position. These corrections may thereby be used for the correction of the measured positions of other GNSS user receivers. These corrections may be transmitted to Central Server 256 in augmentation messages in messages 210, for example (which may be treated differently than fault messages originating at User Segment 252). The corrections may be treated by Central Server 256 as being local to the WARN reference station that provided the corrections in the case of corrections that relate to atmospheric phenomena (e.g. ionospheric delay) and may be provided to UEs in the neighborhood of the WARN reference station to enable these UEs to correct measurements (e.g. pseudorange measurements) made by the UEs. In addition, Central Server 256 may combine corrections received from multiple WARN reference stations into corrections that may be applicable to a large area (e.g. a country, continent or even whole World). A process to combine corrections received from multiple WARN reference stations may include interpolation or extrapolation of corrections to locations not associated with any particular WARN reference station. For example, if three reference stations in WARN 258 each provide pseudorange corrections associated with local atmospheric (e.g., ionospheric and/or tropospheric) delay at the location of each WARN reference station, Central Server 256 may interpolate between or among the three corrections to infer a correction that would apply at any location within a triangle with three vertices defined by the three WARN reference stations. In performing such interpolation and extrapolation, Central Server 256 may make use of additional data such meteorological data (e.g., from a weather bureau and/or weather stations).

In a particular implementation, Control Segment 260 may support or enhance reliability/integrity of an associated GNSS. Nominal GNSS operational performance for particular GNSSs may be specifically defined for the particular GNSSs. A role of WARN 258 may be to support or enhance the reliability/integrity for a particular GNSS which may be based on specific requirements for the particular GNSS, and possibly based on specific requirements for other GNSSs that may be supported by WARN 258.

In particular implementations, WARN reference stations may comprise fixed entities and may have constraints based on power source and power consumption. In other implementations, WARN 258 may take advantage of “UE-derived” WARN reference stations for use in supporting GNSS augmentation and/or reliability/integrity systems. The “UE derived” WARN reference stations may comprise consumer UEs that have a capability, similar to though possibly less accurate than that of a normal WARN reference station, to detect faults in SV signals and/or provide measurements or other data to a Central Server 250 or another server that can enable the Central Server 250 or other server to determine faults and/or corrections to pseudorange measurements. In the case of UE derived WARN reference stations, Central Server 250 or another server may aggregate and combine faults reports and/or corrections inferred from provided measurements (e.g. via averaging) in order to increase the accuracy and reliability of reported faults and/or inferred corrections and reduce the UE specific error components in such reported faults and inferred corrections.

In one implementation, Central Server 256 may receive augmentation or assistance feeds (e.g., in messages 210) and aggregate received augmentation or assistance feeds to deliver a coherent set of augmentation messages (e.g., including updated assistance parameters or correction parameters) to the User Segment 252 in messages 205. In a particular embodiment, messages 210 may provide SV orbit parameters involving SV position and clock data to Central Server 256 to improve the Time To First Fix (TTFF) for participating UE's. In a particular embodiment, Central Server 256 may comprise an Assistance Server (not shown) for use in Assisted GNSS (AGNSS) operations.

In particular implementations, a UE may operate in a mode to obtain GNSS positioning assistance in messages received from Central Server 256. In an example implementation, the Secure User Plane Location (SUPL) solution from the Open Mobile Alliance (OMA), which makes use of Internet Protocol (IP) based protocol communication, may enable a UE to receive assistance information for GPS and/or other GNSS satellites quickly (e.g. within a few seconds or less) from Central Server 256. Alternately, a UE may operate in a standalone mode without communication with Central Server 256. In this case, however, a UE may receive and determine (e.g., demodulate) essentially the same assistance data (e.g. navigation data) including SV position and clock data, which may take 30 or more seconds. In yet another alternate mode, Central Server 256 may feed participating UE's with a so called “Long Term Orbit” in which modeled SV ephemeris and clock data for say a seven to thirty day period may be periodically sent to the UE (e.g., every seven to thirty days).

Augmentation parameters provided from Central Server 256 may be transmitted in augmentation messages to a UE to enable improvement in the quality or timeliness of GNSS measurements or positioning. For example, augmentation parameters may comprise a set of assistance parameters that may include SV ephemeris (position) and clock parameters. Additional assistance parameters may include a characterization of satellite ephemerides (e.g. orbits/positions) that may be useful over a longer period of time, also often known as long term orbits, for example. This may also include clock/timing models over this longer period of time. Augmentation parameters may also comprise a set of correction parameters such as orbit (e.g. ephemeris or SV position data) and time/clock corrections, for example.

In addition to providing assistance parameters to Central Server 256, messages 210 may provide augmentation parameters such as differential corrections for pseudorange and/or carrier phase or absolute corrections for SV. Here, Central Server 256 may process messages 210 to derived assistance parameters to be transmitted to UEs in message 205. Assistance parameters may be provided to UEs in messages 205 infrequently or frequently, including in real-time.

According to an embodiment, a UE may be configured to analyze SPS signals from one or more GNSS constellations to detect particular conditions indicative of a potential SV error, fault in one or more SV's in one or more constellations, or a local jamming event. If a UE detects such a condition, the UE may be configured to transmit a “fault message” to Central Server 256, accompanied with parameters that may include, for example, UE location, current time-stamp and/or time duration. Such a GNSS fault message from a UE to Central Server 256 may be transmitted in messages 206, for example. It should be understood that Central Server 256 may receive fault messages from multiple different, geographically dispersed, UEs from around the globe. Additionally, fault messages from any particular UE may be based on analysis of conditions particular to multiple different GNSS constellations.

Examples of a fault condition that a UE may detect may include, for example: (i) an inability to detect and measure a signal from a particular SV (e.g. after making an attempt based on assistance data provided earlier by Central Server 256); (ii) an inability to detect and measure a particular signal (e.g. at a particular frequency) from a particular SV (e.g. after successfully detecting and measuring a different signal at possibly a different frequency from the same SV); (iii) detection of a signal strength from a particular SV that is significantly higher than that for other SVs in the same GNSS constellation (or in other GNSS constellations) and may thus indicate jamming or spoofing; (iv) measurement of a pseudorange for a particular SV that appears to have a significant error component due to being inconsistent with pseudoranges measured for other SVs in the same GNSS constellation (or in other GNSS constellations) and thereby may be discarded for the purposes of UE location determination; and (v) determination of a location for the UE from pseudorange measurements for SVs in one or more constellations that is inconsistent with a recent previous location for the UE or with a current UE location determined by other means (e.g. using a different GNSS constellation or by looking up a serving cell ID, other visible cell ID or visible or serving WiFi access point (AP) MAC address in a database provided by Central Server 250 or by another server). While indicating a fault condition to Central Server 256 (e.g. in messages 206), a UE may include not only the detected fault condition(s), but also the identity or identities of the GNSS constellation(s), SV(s) and/or SV signal(s) associated with each of the determined fault conditions and details of measurements made by the UE including both apparently correct measurements and apparently incorrect measurements. Central server 250 may then aggregate the fault reports sent by many UEs and look for: (i) similar or identical faults reported by UEs in the same local area and at around the same time (e.g., within 10 minutes to one hour of each other) which may indicate jamming, spoofing or some other interference condition in that local area; (ii) similar or identical faults reported in association with particular SVs belonging to the same GNSS constellation by UEs over a wide area (e.g. part of a country, a whole country, a continent) which may indicate a systemic fault or failure in particular SVs or of a whole GNSS constellation; (iii) faults reported by UEs that have recently received new assistance data (e.g. from Central Server 256) but not by UEs that did not receive new assistance data which may indicate faults in the assistance data sent to those UEs arising, at least in part, from incorrect information received from a reference network such as WARN 258; or (iv) any combination thereof. Control server 256 may then instruct UEs not to attempt acquiring and measuring particular SV signals, signals transmitted by particular SVs, and/or signals transmitted by SVs in a particular GNSS constellation for which some fault has been inferred. Instruction from control server 256 to the UEs may be in the form of indicating an explicit fault in particular SVs, particular SV signals and/or particular GNSS constellations. Alternatively or in addition, central server 256 may instruct UEs to attempt to use other SVs, other SV signals and/or other GNSS constellations while obtaining a UE location or measuring SV pseudoranges—e.g. by instructing UEs only to use SVs, SV signals and/or GNSS constellations for which Central Server 256 is not aware of any faults.

According to an embodiment, in addition to determining augmentation feeds to be provided to Central Server 256, WARN 258 may also analyze SPS signals from the one or more GNSS constellations being monitored to detect conditions indicative of SV error faults in one or more SV's in one or more GNSS constellations. Here, a WARN reference station may be configured to send a fault message or “integrity message” to Central Server 256. Such a GNSS fault message or integrity message may be transmitted from a WARN reference station to Central Server 256 in messages 211. In particular implementations, fault messages or integrity messages may be similarly transmitted from multiple different, geographically dispersed, WARN reference stations. For a given reference station, fault or integrity messages may be based on observations of one or more GNSS constellations.

While measurements or observations indicative of GNSS faults may be obtained at WARN 258 or at a UE, identification, detection or determination of a GNSS fault may be performed at the UE, WARN 258 or Central Server 256. Alternatively, actions to identify, detect or determine a GNSS fault based on these measurements or observations may be split or shared among the UE, WARN 258 and Central Server 256. For example, some fault identification functions may be performed in the UE and not in Central Server 256. Alternatively, there may be cases in which both the UE and WARN 258 may participate in a system to identify potential GNSS faults.

According to an embodiment, Central Server 256 may process fault messages received from WARN 258 in messages 211 and received from UEs in messages 206. For example, based on fault messages received from WARN 258 and UEs, Central Server 256 may apply logic to determine probable SV and/or GNSS constellation errors and/or local jamming/spoofing events. For a local jamming event, for example, Central Server 256 may estimate a location (or affected region) of the event based, at least in part, on a number and distribution of fault messages from UE reporting conditions indicative of the event. For example, an estimated location of a jamming or spoofing event may be equated to an area over which many UEs report an inability to acquire and measure signals from a particular GNSS or report inconsistent, unexpected or incorrect signal strength or pseudorange measurements for a particular GNSS constellation. A probable location of the jammer or spoofer may also be inferred from the distribution of the severity of the fault reports—e.g. a jammer or spoofer using omnidirectional transmission may be expected to contribute to the most severe faults nearby to the jammer or spoofer in all directions and contribute to less severe faults at greater distances. Conversely, a jammer or spoofer with directional transmission may contribute to the most severe faults predominantly in one direction nearby the jammer or spoofer and lesser faults at greater distances.

In one implementation, Central Server 256 may transmit messages 207 to select participating UEs and transmit messages 217 to participating WARN reference stations. In particular implementations, messages 207 and 217 may comprise configuration commands to UEs and/or WARN reference stations to obtain and report observations indicative of certain types of fault (e.g. a fault or faults that Central Server may have inferred from fault reports received from some UEs or may suspect from receipt of inconsistent or erroneous GNSS measurements from UEs and needs to be confirmed and/or augmented with further fault reports from other UEs). Such configuration commands may indicate, for example, particular conditions or events to be observed, threshold values to be applied to measurements in determining whether a fault condition exists or event of interest has occurred, just to provide a few examples. Additionally, Central Server 256 may similarly transmit messages 219 to select participating GNSS Master Control Stations (MCS) and messages 209 to select participating Authorities and/or Infrastructure entities 254. In a particular implementation, message 209 may report to Authorities or Infrastructure entities 254 inferences of local jamming or spoofing. For example, a message 209 may prompt police or other officials to investigate or take other action. In particular implementations, messages 209 may be processed or handled by key “civil infrastructure” entities operated by the private sector and/or local or state governments, such as water, gas, and electricity utility entities, just to provide a few examples.

According to an embodiment, message 219 may report conditions or events related to a GNSS constellation that were not reported by the GNSS operator. In response to message 219, in a particular implementation, a GNSS operator at control segment 260 may be informed of particular inferences determined at Central Server 256, and may then gather additional measurements, reports, etc. related to these inferences. For example, a GNSS operator at control segment 260 may further query sources of observations regarding inferences in message 219 (e.g., other sources to confirm or disconfirm inferences reported in messages 219). In a particular implementation, messages 207 may be combined with messages 205 using standardized OMA SUPL messaging, for example. In particular implementations, fault messages may be received from UEs that are not selected via messages 207 in addition to UEs that are selected to participate.

In one particular implementation, Central Server 256 may process fault messages received from UEs and/or WARN reference stations to infer a high probability of the occurrence of a fault event (e.g., to a predetermined high probability level such as 95% or 99%). For example, this may be determined by associating “like” or “similar” observations in fault messages from UEs and/or WARN reference stations in a specific geographic region, which may indicate a local jamming or spoofing event occurring locally in the specific geographic region. In another embodiment, Central Server 256 may associate “like” or “similar” fault messages from widely geographically dispersed UEs and/or WARN reference stations (e.g., over geographic regions such as on different continents) to infer a global or regional GNSS fault to a given probability level. In particular implementations, detection of conditions indicative of a fault determined at a UE or WARN reference station may involve the application of a threshold value to one or more measurements or observations obtained at the UE or WARN reference station (e.g., measurements or observations of signal to noise, pseudorange measurements, RTK data, time/clock parameters, coordinates of a location estimate, estimated velocity, estimated acceleration, measured PDOP, angle of arrival, etc.). In one aspect, Central Server 256 may determine such threshold values based, at least in part, on an assumed probability of reporting a false error and an assumed probability of not reporting an actual error. Central Server 256 may provide such threshold values to WARN reference stations in messages 217 and provide such threshold values to UEs in messages 207.

According to an embodiment, Central Server 256 may maintain a database to store interference event reports and other event reports associated with possible faults including details of particular events such as, for example, event type, event time, event duration, event history (such as outage history), just to provide a few examples. This database may be distributed over multiple different hosting entities such as different agencies for their own purposes such as an Aviation Authority tracking event database for particular events relating to or affecting aviation. It should be understood that the messaging shown in FIG. 2 are merely examples of messaging that may be used between or among the entities illustrated, and that claimed subject matter is not limited in this respect.

In a particular implementation, Earth Rotation Parameters (ERP) may be used to assist in tracking GNSS space vehicles (SVs) and estimating navigation parameters. In particular scenarios, small and large forces such as weather and earthquakes may cause the Earth to “wobble” which may affect GNSS accuracy. An orientation of the Earth may be captured in Earth orientation/rotation parameters or ERPs and may be used in navigation. ERPs may include, for example, the earth's polar motion (PM, e.g., measured in micro arc seconds) and Length of Day (LOD, e.g., measured in milliseconds), whose measurements and modeling fundamentally influence the orbits of the GNSS SVs by virtue of their use by the GNSS monitor and control segments.

GNSS and other technologies like Very Long Baseline Interferometry (VLBI) and Satellite Laser Ranging (SLR) may be used in determining ERPs by comparison and aggregation across independent sources. As the number of GNSS constellations and GNSS receivers increase, a GNSS may increasingly be utilized in providing ERP determinations at increasingly high precision and high temporal resolution. These ERP determinations may be assessed by comparison to scientific entities such as the International Earth Rotation Service (IERS) that also receives data from other measurement entities.

In certain scenarios, ERP errors may impact aircraft orbits and missile trajectories, for example. GNSS systems may therefore be increasingly responsive to determinations of ERP parameters and anomalies. According to an embodiment, consistency and quality of ERPs for proper operation of a GNSS constellation may be managed at Central Server 256. However, in particular system implementations, entities other than Central Server 256 may compute ERPs and determine potential anomalies. In a particular implementation, messages 217 or 219 may provide relevant ERP indicators (e.g., measurements, estimates of ERPs, etc.) to Control Segment 260 or WARN 258. Alternatively, WARN 258 may provide relevant ERP indicators to Central Server 256 in messages 210 based, at least in part, on observations obtained at one or more WARN reference stations. In another alternative implementation, Central Server 256 or WARN 258 may send a message flow with measurements or observations to a different server entity (not shown) to compute particular ERP indicators based on the measurements or observation.

Communication between Central Server 256 and a UE using messages 205 to provide GNSS assistance messages, including navigation message contents of SV position and clock offsets, is discussed above. Additional parameters such as continuous and/or real-time augmentation messages including, for example, differential corrections for pseudorange and/or carrier phase may be provided in messages 205 or messages 207.

According to an embodiment, UEs of User Segment 252 may elect to receive messages 205 (e.g., to receive augmentation parameters) from Central Server 256, or may elect to operate in a standalone mode without communication with Central Server 256. Some particular UEs may not be capable of receiving or using augmentation parameters in messages 205 (e.g., from time to time if a connection to Central Server 256 is not available). In one example, not receiving the server “assistance” messages from Central Server 256 may lead to longer time-to-first-fix (TTFF). In another example, not receiving the server augmentation messages such as for differential corrections may lead to a more inaccurate position determination.

According to an embodiment, a UE may elect to receive specific messages or message types based on a configuration methodology, as enabled by messages 208. Similarly, a reference station in WARN 258 may elect to receive specific messages or message types based on a configuration methodology as enabled by messages 212. Messages 208 and 212 are shown as bidirectional as participation may be dynamic and initiated and/or terminated by messaging from either Central Server 256, or a UE in User Segment 252 or a reference station in WARN 258. In one example, Central Server 256 may request UEs in a specific event area to undertake specified measurements to assist in confirmation of an event or condition as reported by one or more other UEs in the specific event area. In another example, a UE may have a depleted battery life and send a message to Control Server 256 indicating its unavailability.

Similar procedures may establish participation modality of a UE in connection with messages 207. Similar procedures may also establish a participation modality of entities receiving fault messages via messages 217 to WARN reference stations, messages 219 to Control Segment 260, and messages 209 to authorities or infrastructure entities 254, for example.

In a particular implementation, messages 209 may comprise messages transmitted from Central Server 256 to relevant authorities including governmental authorities, infrastructure agencies including public safety, and/or other entities, just to provide a few examples. As shown, messages 209 may be transmitted in addition to messages 207 transmitted to smartphone and/or other mobile devices belonging to civil users. Message 209 may indicate likely detection of a GNSS event based on a GNSS system fault, or a localized jamming, spoofing, or meaconing event, for example. In an alternative implementation, messages may be transmitted from an authority or infrastructure entity to Central Server 256 in response to a message 209. This may take the form of a request for more detail related to the identified fault. While particular messages between entities shown in FIG. 2 may be shown as being unidirectional, in particular implementations, particular messages shown as being unidirectional may be bi-directional.

In this context, augmentation refers to methods to improve GNSS positioning performance, such as accuracy, reliability, time to first fix and availability, through the integration of external information into processes for computing navigation parameters at a receiver or UE. In particular examples, augmentation may enable a UE receiver to meet accuracy or time requirements of particular applications. In this context, augmentation parameters may comprise “assistance parameters” and/or “correction parameters.”

In particular implementations, Central Server 256 may derive assistance parameters and/or correction parameters based, at least in part, on observations obtained from WARN reference stations and/or UEs. Central Server 256 may transmit messages comprising augmentation parameters regarding SV's in a GNSS above the horizon at a given time, SV frequency and code-phase, SV position/clock and differential corrections for pseudorange and/or carrier phase measurements, corrections for atmospheric contributions, including troposphere and ionosphere, just to provide a few examples. Assistance parameters may also indicate a frequency/code-phase space to search for a particular SV signal. Other augmentation parameters may provide higher accuracy SV position/clock data, pseudorange corrections, and carrier phase corrections which may assist a UE in deriving its position faster and/or with higher accuracy. An SV position or predicted set of positions may also be referred to as ephemeris or orbital data. Both SV ephemeris (position/orbit) and clock (timing) data may be provided to and used by a UE in estimating its location. Augmentation parameters may also indicate atmospheric corrections to be applied to a measured pseudorange and/or to a measured carrier phase. Atmospheric corrections may include tropospheric and ionospheric corrections. Tropospheric corrections may be determined by a WARN reference station or stations (or possibly by UEs acting as less accurate WARN reference stations) using measurements of one GNSS broadcast frequency. Ionospheric corrections may be similarly determined by measurements of two or more GNSS broadcast frequencies, for example.

According to an embodiment, an SV position/clock may be used by a UE to estimate its location. In one implementation, an SV in a GNSS may broadcast accurate SV position/clock data directly to a UE as “broadcast ephemeris.” In a particular implementation, broadcast ephemeris and clock data may be updated periodically by Control Segment 260 (such as every two hours). In one particular mode, a reference network with an assist server may determine SV broadcast ephemeris and clock parameters, and transmit these parameters to UEs. Broadcast ephemeris or augmentation parameters derived by an assistance server may be described as nominally providing “short term” orbit/ephemeris data that grows inaccurate with time. Other augmentation methods of assisting UE's in determining an SV position and/or SV clock, may comprise use of a “long-term” orbit model, and including accurate real-time SV position/clock data.

Possible parameters provided in messages from an assistance server (e.g., Central Server 256) may comprise one or more of the following: UE location (e.g. as determined approximately by the assist server and/or the UE); SV predicted positions for all SVs (e.g. azimuth, elevation); SV predicted positions for SVs above the UE horizon (e.g., for each UE given its approximate location); SV angle of arrival for all SVs; SV angle of arrival for SVs above the UE horizon (e.g., for each UE given its approximate location); SV navigation message (e.g., Navigation data bits); SV ephemeris (e.g., position/orbit); SV almanac; SV clock/timing corrections (e.g., SV navigation time); SV atmospheric corrections, including ionospheric and/or tropospheric corrections; SV predicted code phases or relative delay, e.g. a specified value; SV predicted code phase confidence intervals (e.g., a specified code phase “search window” for an SV) or SV predicted Doppler shifts.

In one aspect, augmentation may refer to systems that may improve or enhance aspects of GNSS operation such as performance (such as enhanced position (or PVT) accuracy), and reliability (integrity). In one implementation, an augmentation system may improve performance using assistance parameters, correction parameters, or some combination thereof. Augmentation aspects can be described as derived and executed in real-time (e.g., time scale of seconds) or non-real-time (e.g., time scale of hours, days or weeks). Augmentation parameters may include “approximate” or “accurate” values, which are relative terms appropriate to a manner in which they are derived in a reference station or reference network, and executed in a UE. Augmentation parameters may be distinguished by being “absolute” or “relative” as processed in a UE. “Absolute” means that a particular message value may be used “as is” from a message source (e.g., replacing or substituting UE parameters). On the other hand, “relative” augmentation parameters means values to “correct” (e.g., additively correct) measurements made by the UE.

According to an embodiment, assistance parameters in a broadcast message may include SV orbit/clock data corresponding to an uplink message from Control Segment 260. These assistance parameters may be derived by a reference network and made available by Central Server 256, such as on-demand from a UE, and may be designated as a non-real time delivery. These assistance parameters may be appropriate for a “shorter” or a “longer” time scale, where a “longer” time scale product is often referred to as a long term orbit, and may be used by a UE in an absolute fashion (e.g., used “as is” in position determination as discussed above).

According to an embodiment, real-time orbit/clock correction parameters in an augmentation message may include accurate SV orbit/clock data, such as for an entire GNSS constellation. These correction parameters may be derived based on observations from a number of reference stations (e.g., reference stations in WARN 258) exceeding a number of SVs involved in the solution. These parameters may be used by a UE in an absolute fashion (e.g., used “as is” in position determination as discussed above).

According to an embodiment, DGNSS pseudorange correction parameters in an augmentation message may comprise differential corrections involving SV pseudorange corrections. These parameters may be derived by a reference network and made available by one or more DGNSS reference stations or a server, such as in real-time. These parameters may be used by an UE in a relative fashion (e.g., to correct measurements obtained by a UE).

According to an embodiment, DGNSS Carrier phase RTK correction parameters in an augmentation message may comprise SV carrier phase corrections in a Real Time Kinetic (RTK) mode. These parameters may be derived by a reference network and made available by one or more DGNSS reference stations or by a server, such as in real-time. These parameters may be used by a UE in a relative fashion (e.g., used to correct measurements obtained at a UE).

According to an embodiment, parameters in an augmentation message may be derived based, at least in part, on observations obtained by reference stations in WARN 258. For example, parameters in a broadcast assistance message may comprise SV orbit or clock data as observed from a reference station, and may be used by a UE for reducing TTFF. In addition, real-time orbit/clock corrections may enable accurate SV orbit/clock values to be substituted for less accurate values in use by a UE. Also, DGNSS pseudorange corrections may be applied to measured SV pseudoranges. Also, DGNSS carrier phase RTK corrections may be applied to measured SV carrier phases. Other types of correction parameters may include, for example, tropospheric and ionospheric contributions along the SV line of sight to UEs that contribute to pseudorange and carrier phase fluctuations. A dual frequency GNSS receiver may reliably determine ionospheric corrections arising from an ionosphere frequency dependence. Correction parameters may be transmitted to UEs via ground-based (GBAS) or satellite-based (SBAS) augmentation systems such as the U.S. WAAS or the European EGNOS systems, as well as increasingly emerging commercial service companies.

In a particular implementation, an augmentation system may be a ground-based augmentation system (GBAS) which may be referred to as local augmentation, or a space-based augmentation system (SBAS) which may be referred to as regional augmentation, or a combination whereby a GBAS uses an SBAS satellite to increase its footprint up to full global coverage via one or more satellites. These systems may differ with respect to how they deliver messages to UEs. An augmentation system may comprise one or more fixed accurately surveyed ground-based reference stations which take measurements concerning a GNSS constellation, and may comprise one or more radio transmitters to transmit measurements or observations. In a particular implementation, a server may consolidate observations obtained from reference stations. In some cases GBAS or other systems may transmit messages containing measurements or observations via wireline communications, possibly via Internet Protocol infrastructure.

In an implementation of a GBAS, measurements or observations from one or more reference stations may be transmitted to a UE directly, or to a server (e.g., Central Server 256) that communicates with the UE. While a GBAS network may be considered localized, supporting receivers within miles to tens of miles, the term GRAS (Ground based Regional Augmentation Systems) may also be applicable to systems that support a larger, regional area, for example.

According to an embodiment, SBAS measurements or observations may be transmitted to a server that uploads the measurements or observations to a satellite for wide area broadcast to UEs on the ground. Some examples of a GBAS may include, for example, the International Civil Aviation Organization (ICAO) applied to precision approach landing of civil aircraft, which was originally called the Local Area Augmentation System (LAAS), and the U.S. Nationwide Differential GPS System (NDGPS), an augmentation system for users on U.S. land and waterways.

In addition to GBAS and SBAS augmentation systems, aircraft based augmentation systems or ABAS may also be deployed. An ABAS may incorporate techniques such as Receiver Autonomous Integrity Measurements (RAIM) discussed above, inertial navigation checks and other onboard instruments. Particular details of systems may vary based, at least in part, on the provider and nationality of the aircraft.

According to an embodiment, a UE may transmit a fault message in messages 206 in response to detection of one or more anomalies in connection with acquisition of one or more SPS signals transmitted by one or more SVs of one or more GNSSs. As pointed out above, the detected one or more anomalies may indicate a condition that is suggestive of one or more faults. In one particular implementation, a UE may detect an anomaly by comparing measurements or detected characteristics of one or more acquired SPS signals to other parameters such as, for example, navigation parameters (e.g., SV ephemeris, clock bias parameters and almanac) obtained from Central Server 256 in messages 205 or navigation parameters received in messages broadcasted by Space Segment 250. A fault message transmitted in messages 206 may include, for example, an identification of a detected anomaly, a time stamp indicating when the anomaly was detected, an identification of affected SV(s) (e.g., identification of SV(s) transmitting the acquired SPS signals compared with navigation parameters), and an identification of affected GNSS(s). Techniques for detecting particular anomalies are discussed below.

In one example, a UE may receive navigation parameters such as satellite ephemeris, clock bias and almanac data from a data signal in SPS signaling frames in a downlink signal transmitted from an SV. In a particular implementation, the UE may detect an anomaly for generating a fault message in navigation parameters received from Central Server 256 and navigation parameters received from Space Segment 250. For example, the UE may quantify a difference between one or more values in navigation parameters received from Central Server 256 and one or more values in navigation parameters received from Space Segment 250. The UE may then detect an anomaly if that quantified difference exceeds a threshold value.

In another embodiment, a UE may detect an anomaly for generating a fault message based, at least in part, on navigation parameters received from Space Segment 250 and navigation parameters determined from recent position fixes obtained by the UE. For example, the UE may quantify a difference between one or more values in navigation parameters received from Space Segment 250 (e.g., satellite ephemeris, clock bias, and almanac) and one or more values in navigation parameters obtained from one or more recent position fixes. The UE may then detect an anomaly if that quantified difference exceeds a threshold value.

In another embodiment, a UE may detect an anomaly for generating a fault message based, at least in part, on a comparison of a pseudorange and/or pseudorange error to an SV obtained from acquisition of an SPS signal transmitted by the SV and a pseudorange and/or pseudorange error to the SV derived by Central Server 256. In a particular implementation, Central Server 256 may derive this pseudorange and/or pseudorange error to the SV based, at least in part, on messages from one or more WARN reference stations containing measurements obtained for SV signals acquired at the one or more WARN reference stations. Alternatively, a UE may detect an anomaly for generating fault message based on a comparison of the pseudorange and/or pseudorange error obtained from acquisition of the SPS signal and a hysteresis of one or more recently computed pseudoranges and/or pseudorange errors to the SV. For example, the UE may detect an anomaly if a difference between the pseudorange and/or pseudorange error obtained from acquisition of the SPS signal and the pseudorange and/or pseudorange error derived by the Central Server 256 (or hysteresis of recently computed pseudoranges to the SV) exceeds a threshold value. In a particular implementation, the threshold value may be based, at least in part, on a computed or expected pseudorange error.

Similarly, in another embodiment, a UE may detect an anomaly for generating a fault message based, at least in part, on a comparison of a real-time kinematic (RTK) carrier phase and/or carrier phase error detected from acquisition of an SPS signal, and a hysteresis of RTK carrier phase and/or carrier phase error detected in recent acquisitions of the SPS signal. For example, the UE may detect an anomaly if a difference between the RTK carrier phase and/or carrier phase error from acquisition of the SPS signal and hysteresis of carrier phase and/or carrier phase error exceed a threshold value. In a particular example, the threshold value may be based, at least in part, on a computed or expected error in RTK carrier phase.

In another embodiment, a UE may detect an anomaly for generating a fault message based, at least in part, on a comparison of a position and/or position error (or velocity and/or velocity error or acceleration and/or acceleration error) of the UE (which is estimated based on acquisition of SPS signals transmitted by SVs) and a position and/or position error (or velocity and/or velocity error or acceleration and/or acceleration error) of the UE as indicated in navigation parameters received from Central Server 256. For example, the UE may detect an anomaly if a difference between the position and/or position error (or velocity and/or velocity error or acceleration and/or acceleration error) of the UE estimated based on acquisition of SPS signals and the position and/or position error (or velocity and/or velocity error or acceleration and/or acceleration error) of the UE as indicated in navigation parameters received from Central Server 256 exceeds a threshold value. In a particular implementation, the threshold value may be based, at least in part, on a computed or expected error in the estimated position and/or position error (or velocity and/or velocity error or acceleration and/or acceleration error).

Similarly, a UE may detect an anomaly for generating a fault message based, at least in part, on a comparison of a position and/or position error (or velocity and/or velocity error or acceleration and/or acceleration error) of the UE estimated based on acquisition of SPS signals transmitted by SVs and a hysteresis of recently computed estimates of position and/or position error (or velocity and/or velocity error or acceleration and/or acceleration error) of the UE (e.g., adjusted over time based on an estimated trajectory). For example, the UE may detect an anomaly if a difference between the position and/or position error (or velocity and/or velocity error or acceleration and/or acceleration error) of the UE estimated based on acquisition of SPS signals and the hysteresis of recently computed estimates of position and/or position error (or velocity and/or velocity error or acceleration and/or acceleration error) of the UE position exceeds a threshold value. In a particular implementation, the threshold value may be based, at least in part, on a computed or expected error in the estimated position and/or position error (or velocity and/or velocity error or acceleration and/or acceleration error).

According to an embodiment, a UE may estimate its position based, at least in part, on pseudorange measurements to a set of SVs in a GNSS constellation (e.g., pseudorange measurements to four SVs). In particular implementation, a UE may detect an anomaly for generating a fault message based, at least in part, on a comparison of a first estimate of a position (or velocity or acceleration) of the UE determined based on (1) acquisition of SPS signals transmitted by a first set of SVs in a GNSS constellation with (2) a second estimate of the position (or velocity or acceleration) of the UE based on acquisition of SPS signals transmitted by a second set of SVs in the same GNSS constellation. For example, the UE may detect an anomaly if a difference between the first estimate of the position (or velocity or acceleration) and the second estimate of the position (or velocity or acceleration) exceeds a threshold value. In a particular implementation, the threshold value may be based, at least in part, on a computed or expected error in the estimated position (or velocity or acceleration).

In another embodiment, a UE may detect an anomaly for generating a fault message based, at least in part, on a comparison of a first estimate of a position (or velocity or acceleration) of the UE determined based on (1) acquisition of SPS signals transmitted by a first set of SVs in a first GNSS constellation with (2) a second estimate of the position (or velocity or acceleration) of the UE based on acquisition of SPS signals transmitted by a second set of SVs in one or more second GNSS constellations that are different to the first constellation. For example, the UE may detect an anomaly if a difference between the first estimate of the position (or velocity or acceleration) and the second estimate of the position (or velocity or acceleration) exceeds a threshold value. In a particular implementation, the threshold value may be based, at least in part, on a computed or expected error in the estimated position (or velocity or acceleration).

In another particular implementation, a UE may detect an anomaly for generating a fault message based, at least in part, on a comparison of a first estimate of a velocity (or acceleration) of the UE determined based on acquisition of SPS signals transmitted by SVs in a GNSS with a second estimate of velocity (or acceleration) of the UE as determined by one or more inertial sensors (e.g. accelerometers, magnetometers, gyroscopes, barometer) embedded in the UE which may be (though need not be) coupled with a previous position of the UE determined by the UE at an earlier time (e.g. using GNSS or some other method). For example, the UE may detect an anomaly if a difference between the first estimate of velocity (or acceleration) and the second estimate of velocity (or acceleration) exceeds a threshold value. In a particular case, a UE may detect an anomaly if signals from one or more inertial sensors on-board the UE indicate that the UE is in a stationary state (e.g., inertial sensors indicating a zero velocity and acceleration) while SPS signals acquired from a GNSS indicate a non-zero velocity or acceleration—or vice versa. In a particular implementation, the threshold value may be based, at least in part, on a computed or expected error in the estimated velocity (or acceleration).

In particular examples discussed above, a UE may detect an anomaly for generating a fault message based, at least in part, on a comparison of a particular parameter or value (e.g., position, velocity or acceleration, and/or errors associated therewith, of the UE) as determined by the UE from acquisition of an SPS signal transmitted by one or more SVs in a GNSS with the particular parameter or value as determined by a different method or source (e.g., as computed by Central Server 256, as determined by one or more sensors in the UE device or as determined from acquisition of SPS signals transmitted by one or more different SVs). In one particular example, a parameter or value as determined based on acquisition and measurement of SPS signals transmitted by a first set of SVs in a GNSS may be compared with the parameter or value as determined based on acquisition and measurement of SPS signals transmitted by a second, different set of SVs in the same GNSS. In another particular example, a parameter or value as determined based on acquisition of SPS signals transmitted by a first set of SVs in a first GNSS may be compared with the parameter or value as determined based on acquisition of SPS signals transmitted by a second, different set of SVs in a second, different GNSS. In other implementations, a parameter or value determined by the UE based on acquisition of an SPS signal transmitted by the one or more SVs may include a position dilution of precision (PDOP) or GNSS time/clock estimate. This parameter or value may be similarly compared with that for a PDOP or a GNSS time/clock estimate as computed by a different method or source (e.g., as computed by Central Server 256) with a fault condition being inferred and a fault report being generated if the difference in the compared parameter or value exceeds some threshold.

In another implementation, a UE may detect an anomaly for generating a fault message based, at least in part, on a measurement of received power or signal-to-noise ratio (SNR) of an SPS signal acquired and measured from one or more SVs in a GNSS. Here, the UE may model an expected received power or SNR based, at least in part, on distances to respective SVs. For example, the UE may detect an anomaly if a difference between the measurement of received power or SNR and an expected received power or SNR exceeds a threshold value for a predetermined time period, or if the measurement of received power or SNR falls below a threshold value for a predetermined time period.

Similarly, a UE may infer a presence of interference if a measured received power or SNR does not exceed a threshold based, at least in part, on receiver front end saturation for a predetermined time period. Additionally, the UE may apply signal analysis to characterize the detected presence of interference as spoofing, Gaussian interference, swept frequency modulation interference or continuous wave interference, just to provide a few examples. Such a characterization may be indicated in a fault message transmitted to Central Sever 256.

In another implementation, a UE may detect an anomaly for generating a fault message based, at least in part, on an irregularity detected in an SPS signal acquired from one or more SVs in a GNSS. For example, the UE may detect an anomaly if an irregularity in a particular aspect of a waveform detected in the acquired SPS signal differs from an expected aspect or value. In another example, the UE may detect an anomaly if a code waveform detected in the acquired SPS signal differs from a hysteresis of code waveforms detected in recently acquired SPS signals transmitted from the one or more SVs. In one example implementation, a pseudonoise code of 1024 chips modulating a downlink signal transmitted by an SV may have one or more rising or falling edges of the waveform modified in some manner such that transitions between chips occurs slightly early or slightly late relative to expected or nominal timing. This impact may be measured, for example, as a percentage root-mean-square error between a measured and nominal waveform. A large enough percentage root-mean-square error may lead to distortions and biases in pseudorange measurements for a particular SV in question, as well as position estimate errors based on distorted pseudorange measurements.

In particular implementations, variations in troposphere or ionosphere may affect delay of an SPS signal transmitted from an SV in an earth orbit and acquired at a ground-based receiver on Earth. Also, Central Server 256 may furnish values characterizing tropospheric or ionospheric delay as assistance parameters to UEs. These delay values may be useful as corrections to the measured pseudorange and/or carrier phases in the GNSS receiver. Likewise, a UE may estimate these values characterizing tropospheric or ionospheric delays based, at least in part, on acquisitions of SPS signals transmitted from any one of several SVs in a GNSS constellation. In a particular implementation, a UE may detect an anomaly for generating a fault message based, at least in part, on a comparison of values characterizing tropospheric or ionospheric delay estimated based, at least in part, on acquisition of an SPS signal from an SV with those obtained from Central Server 256 in assistance parameters.

In a particular scenario, a presence of an off-angle interferer or spoofer in the vicinity of a particular UE may distort a measured angle of arrival (AoA) of an SPS signal acquired at that particular UE. In a particular embodiment, a UE may detect an anomaly for generating a fault message based, at least in part, on a comparison of a measured AoA of an acquired SPS signal transmitted by an SV in a GNSS with an expected AoA of the SPS signal based on assistance parameters (e.g. GNSS almanac or ephemeris data) received from Central Server 256. For example, a UE may compute an expected AoA of an acquired SPS signal based, at least in part, on an approximate location of the UE and assistance data indicative of a precise or approximate location of an SV transmitting the SPS signal. In one example, the UE may detect an anomaly if a difference between a measured AoA and an expected AoA exceeds a threshold value. In an alternative implementation, a UE may detect an anomaly if a difference between a measured AoA and a hysteresis of recent AoA measurements exceeds a threshold value.

In particular scenarios, a limited number of SVs in a GNSS that are “visible” to a UE may be indicative of an above-threshold geometric dilution of precision (GDOP) in connection with attempts by the UE to obtain a position fix. According to an embodiment, a UE may detect an anomaly for generating a fault message based, at least in part, on a number of detected SVs (e.g., based on SPS signals acquired by the SVs) over a time period (e.g., a number of SVs in view is below a threshold number for a set period of time).

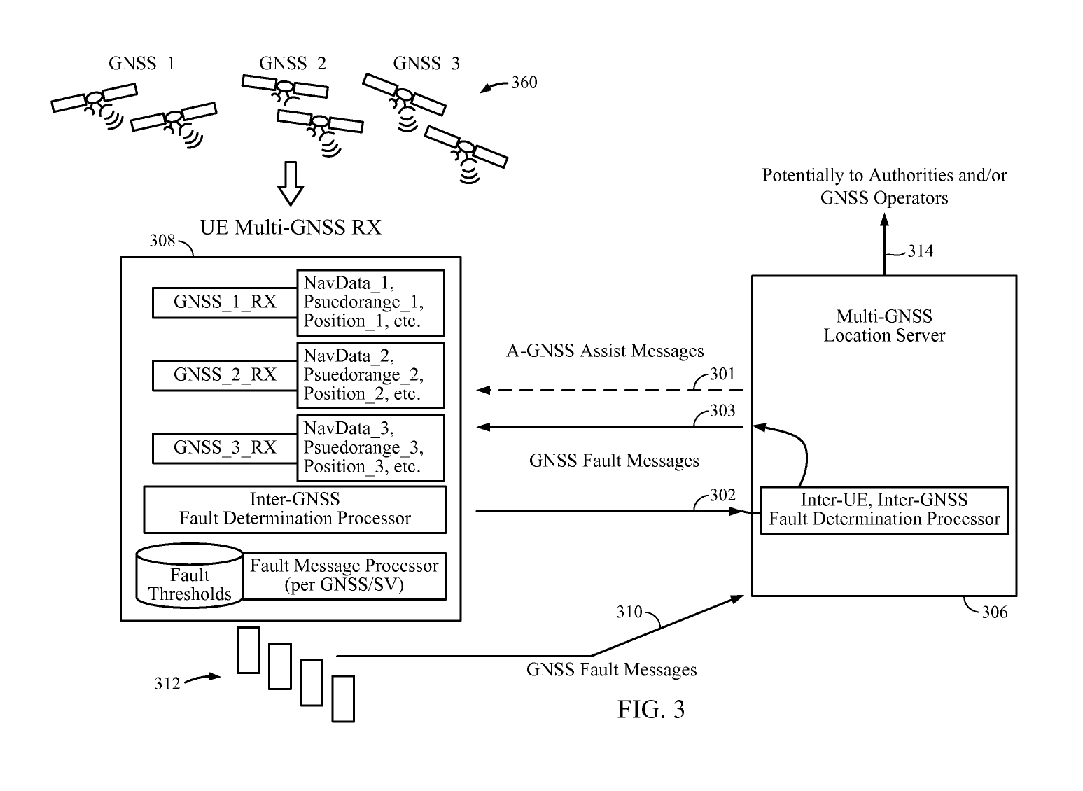

FIG. 3 is a schematic diagram illustrating messaging between a multi-GNSS location server 306 and one or more UEs according to an embodiment. Multi-GNSS Location server 306 may be implemented in Central Server 256 in a particular implementation. GNSS constellations 360 comprise SVs in GNSS constellations GNSS_1, GNSS_2 and GNSS_3, where a constellation label “GNSS_N” may represent any real GNSS such as GPS, Glonass, Galileo, Beidou, QZSS etc. As described above, UE 308 may acquire SPS signals transmitted by SVs in one or more GNSS constellations 360 and detect conditions (e.g., anomalies) that are suggestive of faults or erroneous conditions. UE 308 may then transmit fault messages 302 to multi-GNSS location server 306 in response to detection of the conditions. Also, multi-GNSS location server 306 may transmit augmentation parameters (e.g., correction or assistance parameters) to UE 308 in messages 301. Multi-GNSS location server 306 may also transmit messages 303 providing inferences or detections of faults regarding specific SVs in a GNSS or multiple GNSSs, for example. Alternatively, inferences or detections of faults regarding specific SVs in a GNSS or multiple GNSSs may be bundled with messages 301 including augmentation parameters. Messages 301, 302 and 303 may each correspond to any one or more of messages 205-208 in FIG. 2.

According to an embodiment, UE 308 comprises one or more receivers to receive and process SPS signals transmitted by SVs in multiple, different GNSSs. For example, UE 308 may comprise one or more radio frequency (RF) receivers (not shown) that are used by a single baseband processor (not shown), or shared among multiple baseband processors (not shown), tailored to process SPS signals from corresponding multiple, different GNSSs (e.g., GNSS_1, GNSS_2 and GNSS_3). For example, a multiple baseband processor in UE 308 may be capable of computing pseudorange measurements to SVs in GNSS_1, GNSS_2 and GNSS_3 based on SPS signals acquired from these SVs. Likewise, additional UEs 312 may comprise receivers similarly capable of obtaining pseudorange measurements to SVs in GNSS_1, GNSS_2 and GNSS_3 based on SPS signals. Furthermore, UEs 312 may be capable of transmitting fault messages 310 (e.g. which may correspond to fault messages 302) to Multi-GNSS Location server 306 in response to detecting particular conditions. In particular implementations, UEs 308 and 312 may be geographically dispersed in a local region or GNSS-wide (e.g., globally over the Earth).

Based, at least in part, on fault messages 302 and 310 received from UEs 308 and 312, multi-GNSS Location server 306 may characterize or infer faults or erroneous conditions in connection with SVs in one or more GNSSs among GNSSs 360. In one implementation, multi-GNSS Location server 306 may transmit messages 314 to one or more authorities or operators (e.g., authorities or infrastructure entities 254) to report referred or characterized faults or erroneous conditions. Also, multi-GNSS location server 306 may alter or modify augmentation parameters (e.g., positioning assistance parameters or correction parameters) in messages 301 based, at least in part, on characterized or inferred faults or erroneous conditions. For example, altered or modified augmentation parameters in assistance messages may, for example, indicate that certain SV signals, certain SVs and/or certain GNSS constellations are not available or not reliable for positioning operations. In addition or instead, multi-GNSS location server 306 may request UEs 308 and 312 to acquire and measure only SV signals, only SVs and/or only GNSS constellations that are not known to have faults while requesting any of UEs 308 and 312 to obtain a UE location estimate or return GNSS pseudorange or carrier phase measurements to multi-GNSS location server 306 (e.g., while multi-GNSS location server 306 needs to obtain or compute a location estimate for a UE). In such cases, UE 308 (or any of UEs 312) may avoid searching for compromised SV signals, signals from compromised SVs and/or signals from SVs in a compromised GNSS constellation in favor of searching for other SV signals, signals from other SVs or signals from SVs in another GNSS constellation that are deemed more reliable in each case respectively, for example. In other implementations, multi-GNSS location server 306 may not alter or modify augmentation parameters but instead provide a message indicating that measurements obtained from acquisition of particular SV signals, signals from particular SVs or signals from SVs in a particular GNSS constellation are invalid or not reliable. In yet another implementation, a particular GNSS (e.g., Galileo) may transmit embedded integrity indicators in a downlink signal. Receiving such an integrity indicator indicating that a particular SV signal or a particular SV is invalid, UE 308, a UE 312 or a WARN reference station may not use measurements based on the particular invalid SV signal or signals acquired from the particular invalid SV.

Receiving fault messages indicative of conditions impacting SVs in different GNSSs, multi-GNSS location server 306 may characterize or infer faults or erroneous conditions at SVs in multiple GNSSs. Furthermore, having fault messages indicative of conditions impacting SVs in different GNSSs may enable multi-GNSS location server 306 to identify conditions that are affecting operation of a single GNSS or multiple GNSSs. Such conditions affecting operation of a single GNSS or multiple GNSSs may include, for example, estimates or measurements of particular values for position, velocity, acceleration or timing for a given UE based on measurements obtained from two different GNSSs. For example, a condition indicative of a fault or erroneous condition may be detected if one or more values for position, velocity, acceleration or timing for a given UE based on measurements from a first GNSS are not consistent with similar values for position, velocity, acceleration or timing for the given UE based on measurements from a second GNSS. In one implementation, if UE 308 UE determines that a difference between a first value computed based on signals acquired from a first GNSS (e.g., position, velocity, acceleration or timing) and a second value computed based on signals acquired from a second GNSS exceeds a threshold value, the UE may report this condition in a fault message. Receiving such a message from UE 308, multi-GNSS location server 306 may further diagnose the reported condition. For example, multi-GNSS location server 306 may compare one or more values computed based on signals acquired by different SVs in the first GNSS with values computed based on signal acquired by different SVs in the second GNSS.

Furthermore, receiving fault messages from geographically dispersed UEs 308 and 312, multi-GNSS location server 306 may characterize or infer faults or erroneous conditions locally, regionally or GNSS-wide. For example, multi-GNSS location server 306 may compare and correlate fault messages 302 and 310 by time, space/locality, type of fault, GNSS constellation, SV identifier(s), SV signal identifier(s) just to name a few different attributes by which multi-GNSS location server 306 may correlate fault messages. In one example, multi-GNSS location server 306 may infer that a particular condition is localized to a particular region if similar conditions affecting performance for the same SVs covering a particular local area are detected in the absence of these conditions elsewhere. Similarly, multi-GNSS location server 306 may infer that a particular condition exists or is occurring globally or GNSS-wide if, for example, the particular condition is detected uniformly or is not specifically local to a particular area of region. Multi-GNSS location server 306 may further evaluate other messages received from UEs 308 and 312 that are not fault messages but convey observations of one or more SV signals, one or more SVs and/or one or more GNSS constellations. For example, if correlation of fault messages 302 and 310 indicates a possible fault affecting one or more SV signals, one or more SVs and/or one or more GNSS constellations over a particular area, multi-GNSS location server 306 may evaluate the other non-fault messages to determine whether the same fault over the same area is confirmed, implied or at least indicated as being possible. The other non-fault messages may each comprise various measurements of SV signals performed by UEs 308 and 312 such as measurements of pseudorange, carrier phase, signal to noise ratio, Doppler shift, signal strength and the accuracy or probable error in one or more of these measurements (e.g., a standard deviation for a measurement). The other non-fault messages may be returned by UE 308 or any of UEs 312 to enable multi-GNSS location server 306 to compute a location estimate and/or velocity of the UE—e.g. as part of a positioning procedure for the UE using, for example, the OMA SUPL location solution or the 3GPP control plane location solution for LTE access. Alternatively or in addition, the other non-fault messages may be returned by UEs 308 and 312 as part of crowdsourcing, whereby UEs 308 and 312 periodically return location related observations to multi-GNSS location server 306 (e.g. GNSS measurements and/or measurements of signals received from nearby base stations and/or APs) to enable multi-GNSS location server 306 or some other server to determine status and/or location related information for a network or part of a network.

In one embodiment, multi-GNSS location server 306 may perform fault evaluation and determination entirely using non-fault messages of the types described above. Although the non-fault messages may be returned by UEs 308 and 312 for other purposes (e.g. to support positioning of UEs 308 and 312 and/or to support crowdsourcing), multi-GNSS location server 306 may be able to identify possible faults and anomalies that may be subsequently verified and/or confirmed using additional non-fault messages received from other UEs 308 and 312. As an example, if jamming of a particular GNSS constellation occurs within some local area (e.g. over one or several city or suburban block(s)), multi-GNSS location server 306 may observe that UEs within this local area do not report pseudorange measurements for any SVs belonging to this GNSS constellation and/or report pseudoranges for SVs in this GNSS constellation that do not enable one precise location to be determined using multilateration. Similarly, if a particular SV's clock becomes faulty, multi-GNSS location server 306 may observe that UEs at all locations where the SV is visible report fewer or even no pseudoranges for the particular SV and/or report pseudoranges for the SV that are inconsistent with pseudoranges measured for other SVs. Even though the non-fault messages may not be intended to support fault detection and correction for GNSS constellations, multi-GNSS location server 306 may use the non-fault messages to determine faults and anomalies for particular SV signals, particular SVs and/or a whole GNSS constellation and provide augmentation parameters (e.g., positioning assistance or correction parameters) to UEs 308 and 312 indicative of such faults and anomalies in messages 301.

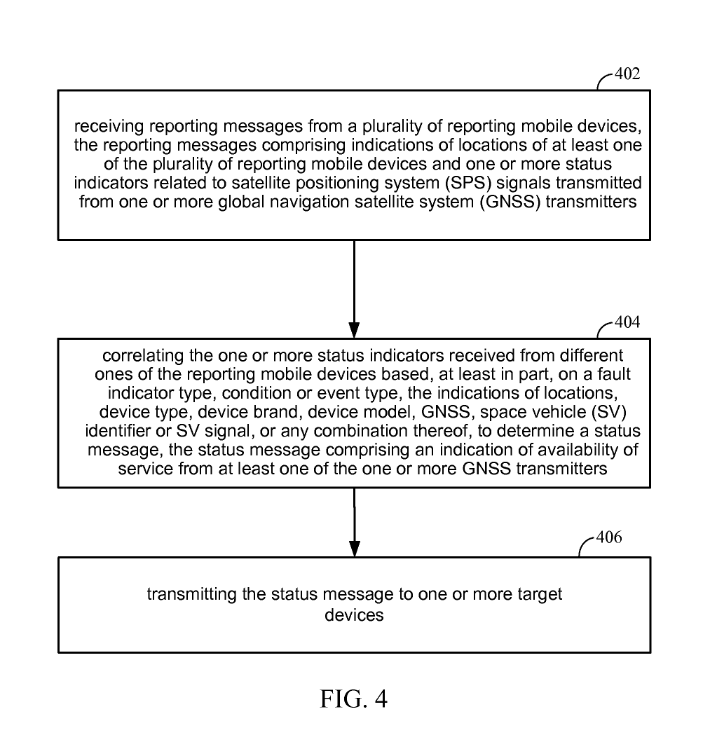

FIG. 4 is a flow diagram of a process for inferring a status of an aspect or portion of a GNSS based on reporting messages received from mobile devices according to an embodiment. In this context, a “status” of an aspect or a portion of a GNSS comprises an indicator of an effectiveness of the aspect or portion to perform a particular function. For example a status of an aspect or portion of a GNSS may be indicative of a reliability or usefulness of the aspect or portion. In one implementation, a status may be indicative of an ability or inability of a GNSS to provide: (i) SPS signals from a particular SV to a location or region to support position operations; (ii) a particular SPS signal from either a particular SV or a plurality of SVs to a location or region to support position operations and/or (iii) SPS signals from any visible SV to a location or region to support position operations. In particular implementations, actions shown in FIG. 4 (e.g. attributed to different blocks in FIG. 4) may be performed, in whole or in part, by a server such as multi-GNSS location server 306 and/or Central Server 256. Block 402 may receive reporting messages (e.g., fault messages 206, 302 or 310) from a plurality of mobile devices such as, for examples, UEs in User Segment 252 (FIG. 2), or UEs 308 or 312 (FIG. 3). Reporting messages received at block 402 may be transmitted according to an LTE positioning protocol (LPP), an LPP extensions (LPPe) protocol or a Secure User Plane Location (SUPL) user plane location protocol (ULP), or any combination thereof, for example. Reporting messages received at block 402 may be further indicated to be fault messages or may be messages used to convey status information or support positioning of a sending mobile device. One or more status indicators in a reporting message received from a UE or other reporting mobile device at block 402 may indicate a condition or event suggestive of a fault or erroneous operation based, at least in part, on SPS signals acquired at the UE. For example, a status indicator may indicate detection of an anomaly or other condition suggestive of erroneous operations using any of the particular examples described above. As discussed elsewhere herein with specific non-limiting examples, such a status indicator may be based, at least in part, on SPS signals received from one or more GNSS transmitters. In addition, a reporting message from a reporting mobile device may also include an indication of a location of the reporting mobile device (e.g., latitude and longitude coordinates, current serving cell identifier, GNSS pseudorange measurements etc.) to assist in localizing reported events and conditions. In a particular implementation, a status indicator in a reporting message received from a reporting mobile device may be based, at least in part, on a comparison of positioning assistance data (e.g., in GNSS downlink or messages from a server) with one or more observations obtained at the reporting mobile device. For example, an observation of a GNSS signal that is inconsistent with positioning assistance data may be indicative of a particular condition or event. In another example, a reporting mobile device may obtain one position fix from acquisition of signals from a first GNSS contemporaneous with one or more additional position fixes from acquisition of signals from one or more additional GNSS′. If the position fix obtained from the first GNSS is different from and an outlier of the one or more additional position fixes, the reporting mobile device may infer the possible presence of a fault in one or more GNSS systems such as due to a spoofing event. In another example, a reporting mobile device may infer a presence of a jammer in the absence of detection of signals transmitted by multiple GNSS systems (e.g., a condition where a wideband noise jammer saturates a GNSS receiver).

Block 404 may correlate status indictors in reporting messages received from two or more reporting mobile devices at block 402 to infer a status of at least a portion or aspect of a GNSS (e.g., specific affected SV, specific affected SV signal or portion of a service area). The inferred status may be used to determine a status message that may describe, summarize, define, imply or otherwise refer to the inferred status. The determined status message may comprise an indication of the availability of service from at least one of the one or more GNSS transmitters.

As described above, status indicators in reporting (e.g. fault) messages received at block 402 from two or more different mobile devices may be correlated by time, indications of locations (e.g., space/locality), condition or event type, fault indicator type, mobile device type, mobile device brand (e.g. mobile device vendor or operator), mobile device model, GNSS system, SV identifier, SV signal or other attributes just to name a few different attributes by which a server performing the process of FIG. 4 may correlate received reporting messages. As pointed out above, correlated status indicators in reporting messages received from different mobile devices may then be used to infer that a particular condition is localized to a particular region or prevalent GNSS-wide, for example. In a particular embodiment, in addition to correlating status indicators in reporting messages received from mobile devices, block 404 may combine indications in reporting messages (e.g., in messages 211) received from WARN reference stations (e.g., in WARN 258) to infer a status of at least a portion of a GNSS (e.g., specific SVs in the GNSS or a portion of a service region covered by the GNSS). In another embodiment, as described above, block 404 may combine indications related to GNSS faults from other non-fault messages received from different mobile devices such as messages provided to enable determination of a location and/or velocity for a UE or messages sent as part of crowdsourcing. In one implementation, status indicators received in reporting messages from reporting mobile device at block 402 may be correlated with fault or other status indicators obtained from WARN reference stations (e.g., in WARN 258). In another implementation, correlating status indicators at block 404 may comprise inferring a condition or an event based, at least in part, on the one or more status indicators.

In one particular implementation, at least one status indicator obtained from a reporting message may indicate detection of an anomaly between or among pseudorange measurements obtained from acquisition of SPS signals transmitted from two or more SVs in the GNSS. In another particular implementation, at least one status indicator obtained from a reporting message may indicate detection of an error in an estimated location or velocity obtained for at least at one mobile device. In another implementation, at least one status indicator obtained from a reporting message may indicate detection of a low or abnormal received power in one or more signals transmitted by an SV in the GNSS and acquired at a mobile device. In yet another implementation, at least one status indicator obtained from a reporting message may indicate detection of a clock error based, at least in part, on detection of a change in a pseudorange rate measured based, at least in part, on one or more SPS signals acquired at a mobile device. In yet another implementation, at least one status indicator obtained from a reporting message may be based, at least in part, on a comparison of one or more values computed by a location server with one or more parameters transmitted by at least one SV in the GNSS such as, for example, ephemeris satellite vehicle (SV) position, SV clock or ionosphere parameters, or any combination thereof. In yet another implementation, at least one status indicator obtained from a reporting message may be based, at least in part, on an atmospheric delay computed based, at least in part, on a comparison between one or more detections at a mobile device in a first SPS frequency band with one or more detections in a second SPS frequency band. In yet another implementation, at least one status indicator obtained from a reporting message may be based, at least in part, on detections of irregular code waveforms from acquisition of signals transmitted from at least one SV in the GNSS. It should be understood, however, that these are merely examples of how an indicator indicative of a condition or event may be determined, and claimed subject matter in not limited in this respect.

Block 406 may transmit the status message determined at block 404 to one or more target mobile devices. According to an embodiment, a status message may be transmitted at block 406 according to an LTE positioning protocol (LPP), an LPP extensions (LPPe) protocol or a Secure User Plane Location (SUPL) user plane location protocol (ULP), or any combination thereof. In some implementations, a status message may provide assistance data to target mobile devices for one or more GNNS systems or may request location measurements or a location estimate from target mobile devices based on one or more GNSS systems. In these implementations, GNSS systems, SVs and/or SV signals with known or suspected faults may be omitted in a status message, indicated as not be used or indicated as having a fault condition. In one implementation, block 406 may transmit one or more status messages determined at block 404 to an operator or authority indicating the presence of an inferred status including, for example, an indication of a particular anomaly or status, a portion of a GNSS affected (e.g., specific SVs or portion of service region), time that status is inferred, just to provide a few examples. In another implementation, block 406 may transmit one or more status messages determined at block 404 to UEs including, for example, updated augmentation parameters (e.g., updated positioning assistance parameters or correction parameters). In another implementation, block 406 may transmit one or more messages to UEs requesting a UE location estimate, and/or one or more SPS measurements, from each UE to enable determination of a UE location estimate, wherein the one or more messages either refrain from including or explicitly exclude the use of particular SV signals, particular SVs and/or particular GNSS constellations that are determined to be associated with a fault condition or anomaly. In one embodiment, a target mobile device receiving a status message transmitted at block 406 may include, for example, a reporting mobile device that provided reporting messages at block 402, mobile devices located within a particular geographic area (e.g., based on indications of locations in reporting messages having status indicators correlated at block 404), or mobile devices located in multiple geographic areas (e.g., if a condition or event is widespread beyond a limited geographical region).

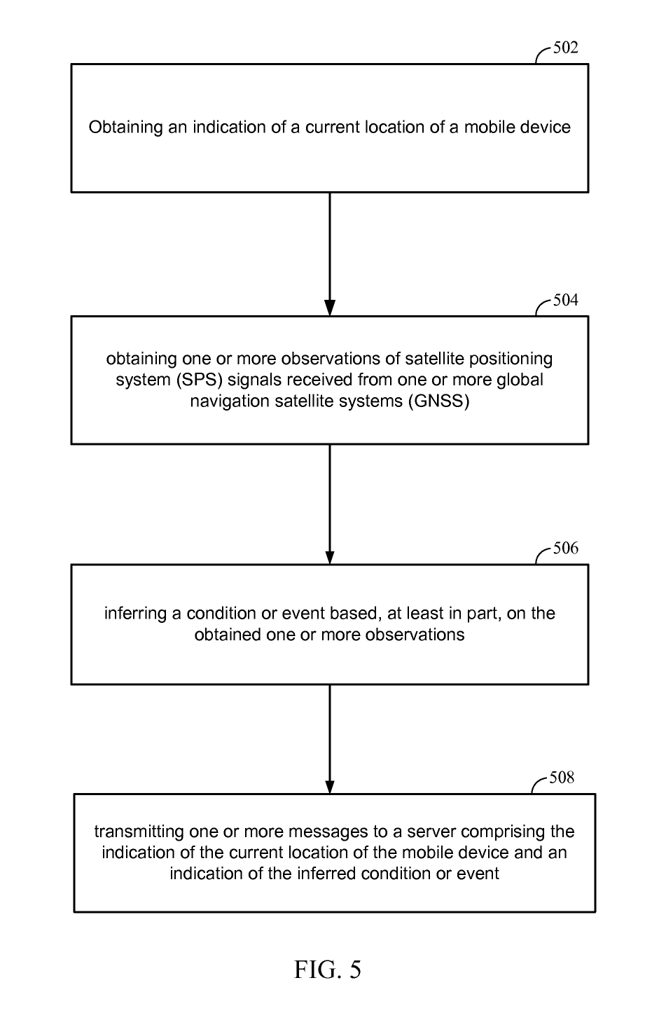

FIG. 5 is a flow diagram of a process at a mobile device (e.g., a UE in User Segment 252, or UE 308 or 312 which may perform the actions attributed to the different blocks in FIG. 5) for providing reporting messages and receiving positioning assistance messages. At block 502, a mobile device may obtain an indication of its current location using any one of serval techniques such as, for example, obtaining a GNSS position fix, obtaining a serving cell identifier, obtaining pseudorange measurements for one or more SVs in one or more GNSS systems, measuring reference signal time differences (RSTDs) for positioning reference signals (PRSs) from terrestrial transmitters, measuring signals from WiFi APs or BTLE beacons, or user input to a user interface, just to provide a few examples. At block 504, the mobile device may obtain one or more observations of SPS signals received from one or more GNSSs. Observations obtained at block 504 may include any one of several types of observations as described herein such as, for example, code phase detections, pseudorange measurement, RF carrier frequency detection or received power measurement. At block 506, a mobile device may infer a condition or event based, at least in part, on the observations obtained at block 504. For example, the mobile device may infer the presence of GNSS system faults or anomalies, faults in individual SVs or individual SV signals as described herein, or localized events or conditions such as spoofing or jamming as discussed above. Block 508 may transmit from a first mobile device one or more reporting messages comprising indications of the condition or event inferred at block 506 and the indication of the location obtained at block 502. For example, block 508 may transmit the one or more reporting messages containing indications of the condition or event inferred at block 506 and the indication of the location obtained at block 502 to a location server (e.g., Central Server 256 or multi-GNSS location server 306).

As discussed above, indications of a condition or event in a message transmitted at block 508 may be indicative of at least one condition, event or anomaly detected at the mobile device based, at least in part, on one or more SPS signals received from a first set of GNSS transmitters. For example, the one or more indications may be indicative of one or more conditions or anomalies as described above. For example, an anomaly may be detected between or among pseudorange and/or carrier phase measurements obtained from acquisition of signals transmitted from two or more SVs in the first set of GNSS transmitters.

According to an embodiment, a mobile device may receive one or more positioning messages from a location server (e.g., Central Server 256 or multi-GNSS location server 306) that include one or more augmentation parameters (e.g., positioning assistance or correction parameters) indicative of a fault or anomaly associated with a set S of GNSS transmitters. For example, the fault or anomaly may be associated with a particular SV signal (for either one particular SV or a plurality of SVs), a particular SV, a particular plurality of SVs or with a whole GNSS constellation. The fault or anomaly may arise, at least in part, from a fault in one or more SVs or in a whole GNSS constellation or may be the result of jamming or spoofing. In an embodiment, the one or more augmentation parameters may comprise positioning assistance parameters comprising an approximate location of the mobile device, GNSS acquisition parameters, GNSS ephemeris or almanac parameters, or any combination thereof. In another embodiment, the one or more augmentation parameters may comprise positioning correction parameters comprising an ephemeris correction, a satellite vehicle position correction or time/clock correction, or any combination thereof. In another embodiment, the one or more augmentation parameters may comprise explicit and/or implicit indications that particular SV signals, particular SVs and/or particular GNSS constellations corresponding to the set S of GNSS transmitters are not to be acquired and/or not to be measured while obtaining a GNSS based location estimate and/or GNSS based location measurements. In an embodiment, the one or more augmentation parameters may be based at least in part on an indication of an inferred condition or event (e.g., in messages transmitted at block 508 by the mobile device and/or by some other mobile device performing the process of FIG. 5). In an embodiment, the one or more positioning messages that are received may correspond to status messages transmitted by a server as at block 406 of the process of FIG. 4.

In an embodiment, a mobile device may obtain one or more first values based, at least in part, on measurement of one or more aspects of an SPS signal acquired at the mobile device from the set S of GNSS transmitters referred to previously. A mobile device at block 506 may then infer at least one condition or event based, at least in part, on a comparison of the obtained one or more first values with one or more second values obtained either from or using a previous augmentation message. The one or more first values may comprise a pseudorange, pseudorange rate, carrier phase, tropospheric delay, ionospheric delay, angle of arrival (AoA), estimated location of the mobile device, estimated velocity of the mobile device, estimated acceleration of the mobile device or real-time kinematic carrier phase, or any combination thereof. In an embodiment, inferring at least one condition or event at block 506 for an event or condition reported at block 508 may further comprise determining whether a difference between at least one of the one or more first values and at least one of the one or more second values exceeds a threshold value. In a further embodiment, the at least one condition or event may be inferred at block 506 based, at least in part, on a comparison of a first value with a second value, the first value being determined based, at least in part, on acquisition at the mobile device of a first SPS signal transmitted from a first SV in a first GNSS, the second value being determined based, at least in part, on acquisition at the mobile device of a second SPS signal transmitted from a second SV in a second GNSS different from the first GNSS.

According to an embodiment, messages transmitted at block 508 may comprise messages transmitted according to the SUPL ULP protocol, the LPP protocol and/or the LPPe protocol. In other implementations, messages transmitted at block 508 may comprise messages transmitted according to extensions of particular messages defined in the SUPL ULP, LPP and/or LPPe standards. In a particular implementation, a location server receiving a message transmitted by a mobile device at block 508 may respond by transmitting an acknowledgement message to the mobile device confirming receipt of the message. In an alternative implementation, a location server receiving a message transmitted by a mobile device at block 508 may respond by transmitting one or more messages to the mobile device requesting, for example, further clarification or more detailed information regarding an event or condition reported in the received message, a history of like or unlike conditions or events, or that the mobile device perform specific future actions to improve detection of events or conditions indicative of a fault. Regarding specific future actions to improve detection of events or conditions indicative of a fault, a location server may transmit one or more command messages to the mobile device to reconfigure the mobile device to alter any implemented methods for detection of particular events or conditions with more detail or granularity. The mobile device may respond to messages from the location server with an acknowledgment message, for example.

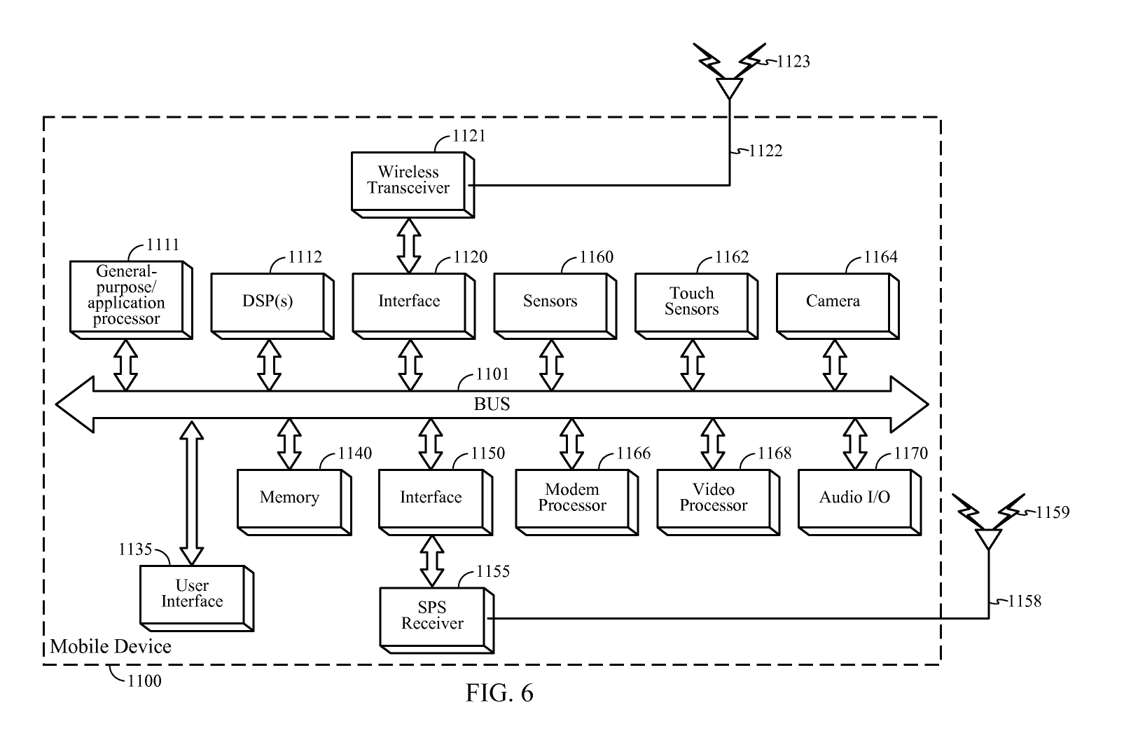

FIG. 6 is a schematic diagram of a mobile device 1100 according to an embodiment. Mobile device 100 (FIG. 1) may comprise one or more features of mobile device 1100 shown in FIG. 6. Mobile device 1100 may correspond to any UE in user segment 252 in FIG. 2 and/or to UE 308 and any of UEs 312 in FIG. 3. In certain embodiments, mobile device 1100 may comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and/or multiple wireless antennas 1122 to enable transmitting and/or receiving signals according to a corresponding multiple wireless communication standards such as, for example, versions of IEEE Std. 802.11, CDMA, W-CDMA, LTE, UMTS, GSM, AMPS, Zigbee and Bluetooth®, Bluetooth low energy (BTLE) just to name a few examples. Signals transmitted and/or received using wireless transceiver(s) and wireless antenna(s) 1122 may comprise one or more of messages 205-208 in FIG. 2 and/or one or more of messages 301-303 and/or 310 in FIG. 3.

Mobile device 1100 may also comprise SPS receiver 1155 capable of receiving and acquiring SPS signals 1159 via SPS antenna 1158. In some implementations, SPS antenna 1158 and wireless antenna 1122 may be the same antenna. SPS receiver 1155 may also process, in whole or in part, acquired SPS signals 1159 for estimating a location of mobile device 1100. SPS receiver 1155 may be connected to bus 1101 by a bus interface 1150. In some embodiments, general-purpose processor(s) 1111, memory 1140, Digital Signal Processor(s) (DSP(s)) 1112 and/or specialized processors (not shown) may also be utilized to process acquired SPS signals (e.g. accessed via bus 1101), in whole or in part, and/or calculate an estimated location of mobile device 1100, in conjunction with SPS receiver 1155. Storage of SPS or other signals for use in performing positioning operations may be performed in memory 1140 or registers (not shown). In some implementations, SPS receiver 1155 and wireless antenna 1122 may support acquisition and measurement of signals from one or more GNSS constellations but not from all GNSS constellations. In these implementations, mobile device 1100 may comprise one or more additional SPS receivers 1155 and/or one or more additional wireless antennas 1122 (not shown in FIG. 6) to enable acquisition and measurement of signals from one or more additional GNSS constellations.

Also shown in FIG. 6, mobile device 1100 may comprise DSP(s) 1112 connected to the bus 1101 either directly (as in FIG. 6) or via by a bus interface 1110 (not shown in FIG. 6), general-purpose processor(s) 1111 connected to the bus 1101 either directly (as in FIG. 6) or via a bus interface 1110 (not shown in FIG. 6) and memory 1140. A bus interface 1110 may be integrated with the DSP(s) 1112, general-purpose processor(s) 1111 and memory 1140. In various embodiments, functions may be performed in response to execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein. In a particular implementation, wireless transceiver 1121 may communicate with general-purpose processor(s) 1111 and/or DSP(s) 1112 through bus 1101 to enable mobile device 1100 to be configured as a wireless STA as discussed above. In combination with wireless transceiver 1121, general-purpose processor(s) 1111 and/or DSP(s) 1112 may execute instructions to execute one or more aspects of processes discussed above in connection with blocks 502 and 504 discussed above.

Also shown in FIG. 6, a user interface 1135 may comprise any one of several devices such as, for example, a speaker, microphone, display device, vibration device, keyboard, touch screen, just to name a few examples. In a particular implementation, user interface 1135 may enable a user to interact with one or more applications and/or one or more functions hosted on mobile device 1100. For example, applications or functions controlled by user interface 1135 may store analog or digital signals, or data derived from such signals, on memory 1140 to be further processed by DSP(s) 1112 or general purpose/application processor 1111 in response to action from a user. Similarly, applications or functions hosted on mobile device 1100 may store analog or digital signals, or data derived from such signals, on memory 1140 to present an output signal or output of data to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Dedicated camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, dedicated video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration or motion of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and/or processed by DPS(s) 1112 and/or general purpose/application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, dedicated modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect. In a particular implementation, SPS receiver 1155 may comprise circuitry and baseband processing capabilities to acquire and process SPS signals transmitted by multiple, different GNSS.

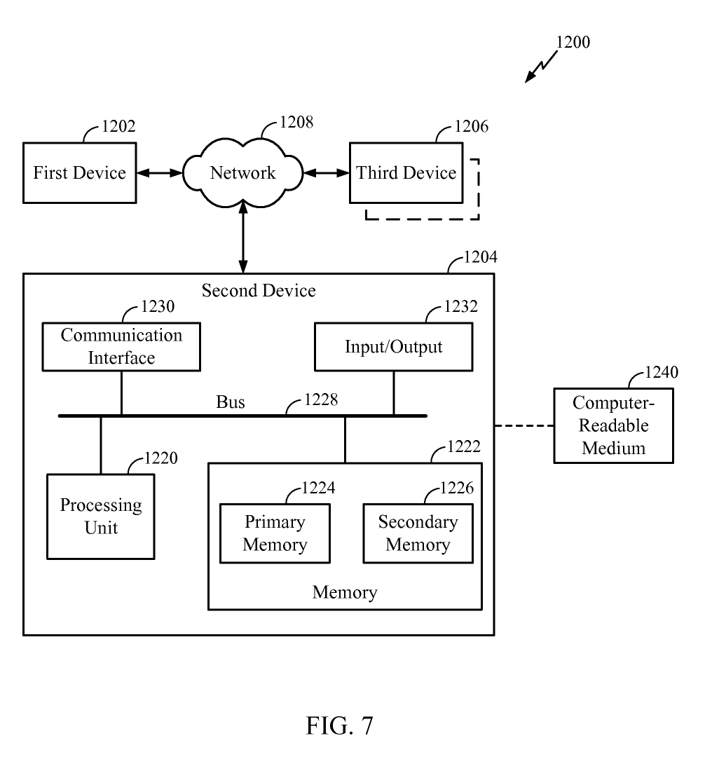

FIG. 7 is a schematic diagram illustrating an example system 1200 that may include one or more devices configurable to implement techniques or processes described above. System 1200 may include, for example, a first device 1202, a second device 1204, and a third device 1206, which may be operatively coupled together through a communications network 1208. In an aspect, second device 1204 may comprise a server (e.g., Central Server 256 or multi-GNSS location server 306) to process fault messages received from mobile devices as discussed above, for example. Also, in an aspect, communications network 1208 may comprise one or more wireless access points, for example, one or more wireless communication networks and/or the Internet. However, claimed subject matter is not limited in scope in these respects.

First device 1202, second device 1204 and third device 1206 may be representative of any device, appliance or machine to process fault messages received from mobile devices. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a location server (e.g. an SLP or E-SMLC), base station almanac server, a base station, or a mobile device in accordance with the examples described herein.

Similarly, communications network 1208, may be representative of one or more communication links (e.g., wired or wireless communication links), processes, or resources configurable to support the exchange of data between at least two of first device 1202, second device 1204, and third device 1206. By way of example but not limitation, communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured by third device 1206, there may be additional like devices operatively coupled to communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220. In combination with communication interface 1230, processing unit 1220 may execute instructions to perform all or portions of actions in blocks 402, 404 and 406.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory storage medium that can carry or make accessible data, code or instructions for one or more of the devices in system 1200. Computer-readable medium 1240 may also be referred to as a storage medium.

Second device 1204 may include, for example, a communication interface 1230 that provides for or otherwise supports the operative coupling of second device 1204 to at least communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

Particular implementations described herein are directed to a location server comprising: means for receiving reporting messages from a plurality of reporting mobile devices, the reporting messages comprising indications of locations of at least one of the plurality of reporting mobile devices and one or more status indicators related to satellite positioning system (SPS) signals transmitted from one or more global navigation satellite system (GNSS) transmitters; means for correlating the status indicators received from different ones of the plurality of reporting mobile devices based, at least in part, on a fault indicator type, condition or event type, the indications of locations, device type, device brand, device model, GNSS, space vehicle (SV) identifier or SV signal, or any combination thereof, to determine a status message, the status message comprising an indication of availability of service from at least one of the one or more GNSS transmitters; and means for transmitting the status message to one or more target devices. In one embodiment, the one or more target devices comprise at least one of the plurality of reporting mobile devices. In another embodiment, the one or more target devices are located within a particular geography based, at least in part, on the indications of locations. In another embodiment, the one or more target devices are located in a plurality of geographies. In another embodiment, the plurality of reporting mobile devices comprise mobile subscriber devices, and correlating the status indicators further comprises: correlating fault indicators obtained from the plurality of reporting mobile devices with one or more fault indicators obtained from one or more WARN reference stations to infer a condition or event. In another embodiment at least one of the status indicators is indicative of a presence of a spoofing condition or event affecting a first GNSS based, at least in part, on a comparison of observations of signals transmitted from at least a second GNSS. In another embodiment, at least one of the status indicators is indicative of a presence of a spoofing condition or event affecting a GNSS based, at least in part, on an estimated location of a reporting mobile device based, at least in part, on acquisition of terrestrial signals. In another embodiment, the reporting messages are transmitted according to an LTE positioning protocol (LPP), an LPP extensions (LPPe) protocol or a Secure User Plane Location (SUPL) user plane location protocol (ULP), or any combination thereof.

Another particular implementation is directed to a non-transitory storage medium comprising computer readable instructions stored thereon which are executable by a processor of a location server to: obtain reporting messages received from a plurality of reporting mobile devices, the reporting messages comprising indications of locations of at least one of the plurality of reporting mobile devices and one or more status indicators related to satellite positioning system (SPS) signals transmitted from one or more global navigation satellite system (GNSS) transmitters; correlate the status indicators received from different ones of the plurality of reporting mobile devices based, at least in part, on a fault indicator type, condition or event type, the indications of locations, device type, device brand, device model, GNSS, space vehicle (SV) identifier or SV signal, or any combination thereof, to determine a status message, the status message comprising an indication of availability of service from at least one of the one or more GNSS transmitters; and initiate transmission of the status message to one or more target client devices. In one embodiment, the computer readable instructions are further executable to infer a condition or event based, at least in part, on the one or more status indicators. In another embodiment, the plurality of reporting mobile devices comprise mobile subscriber devices, and the computer readable instructions are further executable to correlate fault indicators obtained from the plurality of reporting mobile devices with one or more fault indicators obtained from one or more WARN reference stations to infer a condition or event. In another embodiment, at least one of the reporting messages received from at least one of the plurality of reporting mobile devices is based, at least in part, on a comparison of assistance data with at least one observation obtained at the at least one of the plurality of reporting mobile devices. In another embodiment at least one of the status indicators is indicative of a presence of a spoofing condition or event affecting a first GNSS based, at least in part, on a comparison of observations of signals transmitted from at least a second GNSS. In another embodiment, at least one of the status indicators is indicative of a presence of a spoofing condition or event affecting a GNSS based, at least in part, on an estimated location of a reporting mobile device based, at least in part, on acquisition of terrestrial signals. In another embodiment, at least one of the status indicators is indicative of a presence of a jammer based, at least in part, on an absence of detection of signals transmitted by multiple GNSS′. In another embodiment, the status message is transmitted according to an LTE positioning protocol (LPP), an LPP extensions (LPPe) protocol or a Secure User Plane Location (SUPL) user plane location protocol (ULP), or any combination thereof.

Another particular implementation is directed to a mobile device comprising: means for obtaining an indication of a current location of the mobile device; means for obtaining one or more observations of satellite positioning system (SPS) signals received from one or more global navigation satellite systems (GNSS); means for inferring a condition or event based, at least in part, on the obtained one or more observations; and means for: transmitting one or more messages to a server comprising the indication of the current location of the mobile device and an indication of the inferred condition or event. In one embodiment, the means for inferring the condition or event comprises means for comparing positioning assistance data with at least one of the one or more observations of SPS signals. In another embodiment, the positioning assistance data is demodulated from one or more of the SPS signals. In another embodiment, the means for inferring the condition or event comprises means for inferring a presence of a jammer based, at least in part, on an absence of detection of SPS signals transmitted by multiple GNSS′. In another embodiment, the means for inferring the condition or event comprises means for inferring a presence of a spoofing condition or event affecting services from a first GNSS based, at least in part, on one or more observations of SPS signals transmitted by a second GNSS. In another embodiment, the one or more messages are transmitted according to an LTE positioning protocol (LPP), an LPP extensions (LPPe) protocol or a Secure User Plane Location (SUPL) user plane location protocol (ULP), or any combination thereof. In another embodiment, the means for obtaining the indication of the current location of the mobile device further comprises means for acquiring at least one of the SPS signals.

Another particular implementation is directed to a non-transitory storage medium comprising computer readable instructions stored thereon which are executable by a processor of a mobile device to: obtain an indication of a current location of the mobile device; obtain one or more observations of SPS signals received at the SPS receiver from one or more global navigation satellite systems (GNSS); infer a condition or event based, at least in part, on the obtained one or more observations; and initiate transmission of one or more messages through the wireless transceiver to a server comprising the indication of the current location of the mobile device and an indication of the inferred condition or event. In one embodiment, the condition or event is inferred based, at least in part, on a comparison of positioning assistance data with at least one of the one or more observations of SPS signals. In another embodiment, the positioning assistance data is demodulated from one or more of the SPS signals. In another embodiment, the positioning assistance data is obtained from one or more messages received at the wireless transceiver from a location server. In another embodiment, the one or more processors are configured to infer the condition or event by inferring a presence of a jammer based, at least in part, on an absence of detection of SPS signals transmitted by multiple GNSS′. In another embodiment, the computer readable instructions are further executable to infer the condition or event by inferring a presence of a spoofing condition or event affecting services from a first GNSS based, at least in part, on one or more observations of SPS signals transmitted by a second GNSS. In another embodiment, the computer readable instructions are further executable to initiate transmission of the messages according to an LTE positioning protocol (LPP), an LPP extensions (LPPe) protocol or a Secure User Plane Location (SUPL) user plane location protocol (ULP), or any combination thereof.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, smartphone, tablet, user equipment, laptop computer, other personal communication system (PCS) device, personal digital assistant (PDA), personal audio device (PAD), portable navigational device (PND), and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with (i) positioning systems that utilize terrestrial transmitters acting as “pseudolites” that transmit a navigation signal that may be similar to or the same as that transmitted by a conventional earth orbiting GNSS, and/or (ii) with positioning systems that utilize a combination of SVs and such terrestrial transmitters. Terrestrial transmitters may, for example, include ground-based transmitters that broadcast a pseudo-random (PN) code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites. The terms “GNSS” and “GNSS constellation”, as used herein, are intended to include global Earth orbiting SPS systems such as GPS, Galileo and Glonass, regional SPS systems such as the Japanese QZSS system and Indian IRNSS system and terrestrial based systems that may use pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. At a location server, a method comprising:
receiving reporting messages from a plurality of reporting mobile devices, the reporting messages comprising indications of locations of at least one of the plurality of reporting mobile devices and one or more status indicators related to satellite positioning system (SPS) signals transmitted from one or more global navigation satellite system (GNSS) transmitters;
correlating the one or more status indicators received from different ones of the plurality of reporting mobile devices based, at least in part, on a fault indicator type, condition or event type, the indications of locations, device type, device brand, device model, GNSS, space vehicle (SV) identifier or SV signal, or any combination thereof, to determine a status message, the status message comprising an indication of availability of service from at least one of the one or more GNSS transmitters; and
transmitting the status message to one or more target devices.

2. The method of claim 1, wherein the one or more target devices comprise at least one of the plurality of reporting mobile devices.

3. The method of claim 1, wherein the one or more target devices are located within a particular geography based, at least in part, on the indications of locations.

4. The method of claim 1, wherein the one or more target devices are located in a plurality of geographies.

5. The method of claim 1, wherein the plurality of reporting mobile devices comprise mobile subscriber devices, and wherein correlating the status indicators further comprises:
correlating fault indicators obtained from the plurality of reporting mobile devices with one or more fault indicators obtained from one or more WARN reference stations to infer a condition or event.

6. The method of claim 1, wherein at least one of the status indicators is indicative of a presence of a spoofing condition or event affecting a first GNSS based, at least in part, on a comparison of observations of signals transmitted from at least a second GNSS.

7. The method of claim 1, wherein at least one of the status indicators is indicative of a presence of a spoofing condition or event affecting a GNSS based, at least in part, on an estimated location of a reporting mobile device based, at least in part, on acquisition of terrestrial signals.

8. The method of claim 1, wherein the reporting messages are transmitted according to an LTE positioning protocol (LPP), an LPP extensions (LPPe) protocol or a Secure User Plane Location (SUPL) user plane location protocol (ULP), or any combination thereof.

9. A location server comprising:
a communication interface to transmit messages to and receive messages from a communication network; and
one or more processors configured to:
obtain reporting messages received at the communication interface from a plurality of reporting mobile devices, the reporting messages comprising indications of locations of at least one of the plurality of reporting mobile devices and one or more status indicators related to satellite positioning system (SPS) signals transmitted from one or more global navigation satellite system (GNSS) transmitters;
correlate the one more status indicators received from different ones of the plurality of reporting mobile devices based, at least in part, on a fault indicator type, condition or event type, the indications of locations, device type, device brand, device model, GNSS, space vehicle (SV) identifier or SV signal, or any combination thereof, to determine a status message, the status message comprising an indication of availability of service from at least one of the one or more GNSS transmitters; and
initiate transmission of the status message through the communication interface to one or more target client devices.

10. The location server of claim 9, wherein the one or more processors are further configured to infer a condition or event based, at least in part, on the one or more status indicators.

11. The location server of claim 9, wherein the plurality of reporting mobile devices comprise mobile subscriber devices, and wherein the one or more processors are further configured to:
correlate fault indicators obtained from the plurality of reporting mobile devices with one or more fault indicators obtained from one or more WARN reference stations to infer a condition or event.

12. The location server of claim 9, wherein at least one of the reporting messages received from at least one of the plurality of reporting mobile devices is based, at least in part, on a comparison of assistance data with at least one observation obtained at the at least one of the plurality of reporting mobile devices.

13. The location server of claim 9, wherein at least one of the status indicators is indicative of a presence of a spoofing condition or event affecting a first GNSS based, at least in part, on a comparison of observations of signals transmitted from at least a second GNSS.

14. The location server of claim 9, wherein at least one of the status indicators is indicative of a presence of a spoofing condition or event affecting a GNSS based, at least in part, on an estimated location of a reporting mobile device based, at least in part, on acquisition of terrestrial signals.

15. The location server of claim 9, wherein at least one of the status indicators is indicative of a presence of a jammer based, at least in part, on an absence of detection of signals transmitted by multiple GNSS′.

16. The location server of claim 9, wherein the status message is transmitted according to an LTE positioning protocol (LPP), an LPP extensions (LPPe) protocol or a Secure User Plane Location (SUPL) user plane location protocol (ULP), or any combination thereof.

17. At a mobile device, a method comprising:
obtaining an indication of a current location of the mobile device;
obtaining one or more observations of satellite positioning system (SPS) signals received from one or more global navigation satellite systems (GNSS);
inferring a condition or event based, at least in part, on the obtained one or more observations; and
transmitting one or more messages to a server comprising the indication of the current location of the mobile device and an indication of the inferred condition or event.

18. The method of claim 17, wherein inferring the condition or event comprises comparing positioning assistance data with at least one of the one or more observations of SPS signals.

19. The method of claim 18, wherein the positioning assistance data is demodulated from one or more of the SPS signals.

20. The method of claim 17, wherein inferring the condition or event comprises inferring a presence of a jammer based, at least in part, on an absence of detection of SPS signals transmitted by multiple GNSS′.

21. The method of claim 17, wherein inferring the condition or event comprises inferring a presence of a spoofing condition or event affecting services from a first GNSS based, at least in part, on one or more observations of SPS signals transmitted by a second GNSS.

22. The method of claim 17, wherein the one or more messages are transmitted according to an LTE positioning protocol (LPP), an LPP extensions (LPPe) protocol or a Secure User Plane Location (SUPL) user plane location protocol (ULP), or any combination thereof.

23. The method of claim 17, wherein obtaining the indication of the current location of the mobile device further comprises acquiring at least one of the SPS signals.

24. A mobile device comprising:
a wireless transceiver to transmit messages to and receive messages from a communication network;
a satellite positioning system (SPS) receiver; and
one or more processors configured to:
obtain an indication of a current location of the mobile device;
obtain one or more observations of SPS signals received at the SPS receiver from one or more global navigation satellite systems (GNSS);
infer a condition or event based, at least in part, on the obtained one or more observations; and
initiate transmission of one or more messages through the wireless transceiver to a server comprising the indication of the current location of the mobile device and an indication of the inferred condition or event.

25. The mobile device of claim 24, wherein the condition or event is inferred based, at least in part, on a comparison of positioning assistance data with at least one of the one or more observations of SPS signals.

26. The mobile device of claim 25, wherein the positioning assistance data is demodulated from one or more of the SPS signals.

27. The mobile device of claim 25, wherein the positioning assistance data is obtained from one or more messages received at the wireless transceiver from a location server.

28. The mobile device of claim 24, wherein the one or more processors are configured to infer the condition or event by inferring a presence of a jammer based, at least in part, on an absence of detection of SPS signals transmitted by multiple GNSS′.

29. The mobile device of claim 24, wherein the one or more processors are configured to infer the condition or event by inferring a presence of a spoofing condition or event affecting services from a first GNSS based, at least in part, on one or more observations of SPS signals transmitted by a second GNSS.

30. The mobile device of claim 24, wherein the one or more processors are configured to initiate transmission of the messages according to an LTE positioning protocol (LPP), an LPP extensions (LPPe) protocol or a Secure User Plane Location (SUPL) user plane location protocol (ULP), or any combination thereof.
